(19) United States
(12) Patent Application Publication
(10) Pub. No.: US 2024/0118642 A1
(43) Pub. Date: Apr. 11, 2024

(54) TONER FOR ELECTROSTATIC IMAGE DEVELOPMENT, ELECTROSTATIC IMAGE DEVELOPER, TONER CARTRIDGE, PROCESS CARTRIDGE, IMAGE FORMING APPARATUS, AND IMAGE FORMING METHOD

(71) Applicant: FUJIFILM BUSINESS INNOVATION CORP., Tokyo (JP)

(72) Inventors: Yosuke TSURUMI, Minamiashigara-shi (JP); Sakiko TAKEUCHI, Minamiashigara-shi (JP); Yasuko TORII, Minamiashigara-shi (JP); Ryo NAGAI, Minamiashigara-shi (JP)

(73) Assignee: FUJIFILM BUSINESS INNOVATION CORP., Tokyo (JP)

(21) Appl. No.: 18/315,755

(22) Filed: May 11, 2023

(30) Foreign Application Priority Data
Sep. 22, 2022 (JP) 2022-151968

(51) Int. Cl. G03G 9/097; G03G 15/08; G03G 21/18

(52) U.S. Cl. CPC G03G 9/09716; G03G 9/09725; G03G 15/0865; G03G 21/1814

(57) ABSTRACT

A toner for electrostatic image development includes: toner particles; perovskite compound particles externally added to the toner particles; and silica particles (S) that are externally added to the toner particles and include an elemental nitrogen-containing compound containing elemental molybdenum and in which the ratio N_{Mo}/N_{Si} of a Net intensity N_{Mo} of elemental molybdenum that is measured by X-ray fluorescence analysis to a Net intensity N_{Si} of elemental silicon that is measured by the X-ray fluorescence analysis is from 0.035 to 0.45 inclusive.

### CROSS-REFERENCE TO RELATED APPLICATIONS

This application is based on and claims priority under 35 USC 119 from Japanese Patent Application No. 2022-151968 filed Sep. 22, 2022.

### BACKGROUND

### (i) Technical Field

The present disclosure relates to a toner for electrostatic image development, an electrostatic image developer, a toner cartridge, a process cartridge, an image forming apparatus, and an image forming method.

### (ii) Related Art

Japanese Unexamined Patent Application Publication No. 2005-338750 discloses a toner including a fine strontium titanate powder having undergone no sintering step.

Japanese Unexamined Patent Application Publication No. 2019-028235 discloses a toner for electrostatic image development that contains toner particles, silica particles, and strontium titanate doped with lanthanum.

Japanese Unexamined Patent Application Publication No. 2021-151944 discloses silica particles having surfaces treated with a quaternary ammonium salt.

### SUMMARY

Aspects of non-limiting embodiments of the present disclosure relate to a toner for electrostatic image development that includes silica particles externally added to toner particles and including an elemental nitrogen-containing compound containing elemental molybdenum. With this toner, variations in image density are less likely to occur than with a toner in which the ratio N_{Mo}/N_{Si} of the Net intensity N_{Mo} of elemental molybdenum measured by X-ray fluorescence analysis to the Net intensity N_{Si} of elemental Si measured by the X-ray fluorescence analysis is less than 0.035 or more than 0.45.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a toner for electrostatic image development including:
toner particles;
perovskite compound particles externally added to the toner particles; and
silica particles (S) that are externally added to the toner particles and include an elemental nitrogen-containing compound containing elemental molybdenum and in which the ratio N_{Mo}/N_{Si} of a Net intensity N_{Mo} of elemental molybdenum that is measured by X-ray fluorescence analysis to a Net intensity N_{Si} of elemental silicon that is measured by the X-ray fluorescence analysis is from 0.035 to 0.45 inclusive.

### BRIEF DESCRIPTION OF THE DRAWINGS

An exemplary embodiment of the present disclosure will be described in detail based on the following figures, wherein:

FIG. 1 is a schematic configuration diagram showing an example of an image forming apparatus according to the exemplary embodiment; and

FIG. 2 is a schematic configuration diagram showing an example of a process cartridge detachably attached to the image forming apparatus according to the exemplary embodiment.

### DETAILED DESCRIPTION

An exemplary embodiment of the present disclosure will be described below. The description and Examples are illustrative of the exemplary embodiment and are not intended to limit the scope of the exemplary embodiment.

In the present disclosure, a numerical range represented using “to” means a range including the numerical values before and after the “to” as the minimum value and the maximum value, respectively.

In a set of numerical ranges expressed in a stepwise manner in the present disclosure, the upper or lower limit in one numerical range may be replaced with the upper or lower limit in another numerical range in the set. Moreover, in a numerical range described in the present disclosure, the upper or lower limit in the numerical range may be replaced with a value indicated in an Example.

In the present disclosure, the term “step” is meant to include not only an independent step but also a step that is not clearly distinguished from other steps, so long as the prescribed purpose of the step can be achieved.

When the exemplary embodiment of the present disclosure is explained with reference to the drawings, the structure of the exemplary embodiment is not limited to the structures shown in the drawings. In the drawings, the sizes of the components are conceptual, and the relative relations between the components are not limited to those shown in the drawings.

In the present disclosure, any component may contain a plurality of materials corresponding to the component. In the present disclosure, when reference is made to the amount of a component in a composition, if the composition contains a plurality of materials corresponding to the component, the amount means the total amount of the plurality of materials in the composition, unless otherwise specified.

In the present disclosure, particles corresponding to a certain component may include a plurality of types of particles. When a plurality of types of particles corresponding to a certain component are present in a composition, the particle diameter of the component is the value for the mixture of the plurality of types of particles present in the composition, unless otherwise specified.

In the present disclosure, the notation “(meth)acrylic” is meant to include “acrylic” and “methacrylic,” and the notation “(meth)acrylate” is meant to include “acrylate” and “methacrylate.”

In the present disclosure, a “toner for electrostatic image development” may be referred to simply as a “toner,” and an “electrostatic image developer” may be referred to simply as a “developer.” A “carrier for electrostatic image development” may be referred to simply as a “carrier.”

### <Toner for Electrostatic Image Development>

The toner according to the present exemplary embodiment includes toner particles, perovskite compound particles externally added to the toner particles, and silica particles (S) externally added to the toner particles. The silica particles (S) contain an elemental nitrogen-containing compound containing elemental molybdenum, and the ratio N_{Mo}/N_{Si} of the Net intensity N_{Mo} of elemental molybdenum measured by X-ray fluorescence analysis to the Net intensity N_{Si} of elemental Si measured by the X-ray fluorescence analysis is from 0.035 to 0.45 inclusive.

With the toner according to the present exemplary embodiment, variations in image density are less likely to occur. The mechanism for this may be as follows.

In electrophotographic image formation, a toner on an image holding member and on an intermediate transfer body is subjected to an electric field, and the amount of charges on the toner gradually decreases until the toner is fixed onto a recording medium.

The perovskite compound particles have high electric resistance despite their high dielectric constant, so that the reduction in the amount of charges on the toner can be reduced. The perovskite compound particles are suitable for an external additive for toners.

However, when a toner with a perovskite compound externally added thereto is used for continuous formation of images in which charges are easily accumulated on the toner (for example, continuous formation of images with low area coverages in a relatively low humidity environment), an excessively large amount of charges are accumulated on the toner, and leakage of charges occurs. This may cause variations in image density.

The silica particles (S) are silica particles with their surfaces modified by the elemental nitrogen-containing compound containing elemental molybdenum and are an external additive serving as a charge control agent. When the ratio N_{Mo}/N_{Si} in the silica particles (S) is within the prescribed range, the toner with the perovskite compound externally added thereto may be prevented from being charged excessively.

In the present exemplary embodiment, the ratio N_{Mo}/N_{Si} in the silica particles (S) is from 0.035 to 0.45 inclusive.

If the ratio N_{Mo}/N_{Si} is less than 0.035, charge transfer due to nitrogen atoms is remarkable. This causes charge leakage, so that variations in image density are likely to occur. From the viewpoint of avoiding this phenomenon, the ratio N_{Mo}/N_{Si} is 0.035 or more, preferably 0.05 or more, more preferably 0.07 or more, and still more preferably 0.10 or more.

If the ratio N_{Mo}/N_{Si} is more than 0.45, the amount of molybdenum atoms is excessively large. In this case, the amount of charges due to nitrogen atoms is not sufficiently increased, so that unevenness in image density is likely to occur. From the viewpoint of avoiding this phenomenon, the ratio N_{Mo}/N_{Si} is 0.45 or less, preferably 0.40 or less, more preferably 0.35 or less, and still more preferably 0.30 or less.

The total content of the perovskite compound particles and the silica particles (S) is preferably from 0.5 parts by mass to 5.0 parts by mass inclusive, more preferably from 1.0 part by mass to 4.5 parts by mass inclusive, and still more preferably from 1.8 parts by mass to 4.0 parts by mass inclusive, based on 100 parts by mass of the toner particles.

The content of the perovskite compound particles is preferably from 0.2 parts by mass to 3.0 parts by mass inclusive, more preferably from 0.5 parts by mass to 2.5 parts by mass inclusive, and still more preferably from 0.8 parts by mass to 2.0 parts by mass inclusive, based on 100 parts by mass of the toner particles.

The content of the silica particles (S) is preferably from 0.2 parts by mass to 3.0 parts by mass inclusive, more preferably from 0.5 parts by mass to 2.5 parts by mass inclusive, and still more preferably from 0.8 parts by mass to 2.0 parts by mass inclusive, based on 100 parts by mass of the toner particles.

The mass percentage of the silica particles (S) with respect to the total mass of the perovskite compound particles and the silica particles (S) is preferably from 40% by mass to 60% by mass inclusive and more preferably from 45% by mass to 55% by mass inclusive.

The ratio D2/D1 of the average primary particle diameter D2 of the silica particles (S) to the average primary particle diameter D1 of the perovskite compound particles is preferably from 0.45 to 2.00 inclusive, more preferably from 0.50 to 1.70 inclusive, and still more preferably from 0.75 to 1.50 inclusive, from the viewpoint of allowing these particles to be well mixed and dispersed on the surfaces of the toner particles.

The structure of the toner according to the present exemplary embodiment will next be described in detail.

[Toner particles]

The toner particles include, for example, a binder resin and optionally include a coloring agent, a release agent, and additional additives.

### —Binder Resin—

Examples of the binder resin include: vinyl resins composed of homopolymers of monomers such as styrenes (such as styrene, p-chlorostyrene, and α-methylstyrene), (meth)acrylates (such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (such as acrylonitrile and methacrylonitrile), vinyl ethers (such as vinyl methyl ether and vinyl isobutyl ether), vinyl ketones (such as vinyl methyl ketone, vinyl ethyl ketone, and vinyl isopropenyl ketone), and olefins (such as ethylene, propylene, and butadiene); and vinyl resins composed of copolymers of combinations of two or more of the above monomers.

Other examples of the binder resin include: non-vinyl resins such as epoxy resins, polyester resins, polyurethane resins, polyamide resins, cellulose resins, polyether resins, and modified rosins; mixtures of the non-vinyl resins and the above-described vinyl resins; and graft polymers obtained by polymerizing a vinyl monomer in the presence of any of these resins.

One of these binder resins may be used alone, or two or more of them may be used in combination.

The binder resin may be a polyester resin.

Examples of the polyester resin include well-known polyester resins.

The polyester resin is, for example, a polycondensation product of a polycarboxylic acid and a polyhydric alcohol. The polyester resin used may be a commercial product or a synthesized product.

Examples of the polycarboxylic acid include aliphatic dicarboxylic acids (such as oxalic acid, malonic acid, maleic acid, fumaric acid, citraconic acid, itaconic acid, glutaconic acid, succinic acid, alkenyl succinic acids, adipic acid, and sebacic acid), alicyclic dicarboxylic acids (such as cyclohexanedicarboxylic acid), aromatic dicarboxylic acids (such as terephthalic acid, isophthalic acid, phthalic acid, and naphthalenedicarboxylic acid), anhydrides thereof, and lower alkyl (having, for example, 1 to 5 carbon atoms) esters thereof. In particular, the polycarboxylic acid may be, for example, an aromatic dicarboxylic acid.

The polycarboxylic acid used may be a combination of a dicarboxylic acid and a tricarboxylic or higher polycarboxylic acid having a crosslinked or branched structure. Examples of the tricarboxylic or higher polycarboxylic acid include trimellitic acid, pyromellitic acid, anhydrides thereof, and lower alkyl (having, for example, 1 to 5 carbon atoms) esters thereof.

One of these polycarboxylic acids may be used alone, or two or more of them may be used in combination.

Examples of the polyhydric alcohol include aliphatic diols (such as ethylene glycol, diethylene glycol, triethylene glycol, propylene glycol, butanediol, hexanediol, and neopentyl glycol), alicyclic diols (such as cyclohexanediol, cyclohexanedimethanol, and hydrogenated bisphenol A), and aromatic diols (such as an ethylene oxide adduct of bisphenol A and a propylene oxide adduct of bisphenol A). In particular, for example, the polyhydric alcohol is preferably an aromatic diol or an alicyclic diol and more preferably an aromatic diol.

The polyhydric alcohol used may be a combination of a diol and a trihydric or higher polyhydric alcohol having a crosslinked or branched structure. Examples of the trihydric or higher polyhydric alcohol include glycerin, trimethylolpropane, and pentaerythritol.

One of these polyhydric alcohols may be used alone, or two or more of them may be used in combination.

The glass transition temperature (Tg) of the polyester resin is preferably from 50° C. to 80° C. inclusive and more preferably from 50° C. to 65° C. inclusive.

The glass transition temperature is determined using a DSC curve obtained by differential scanning calorimetry (DSC). More specifically, the glass transition temperature is determined from “extrapolated glass transition onset temperature” described in glass transition temperature determination methods in “Testing methods for transition temperatures of plastics” in JIS K 7121-1987.

The weight average molecular weight (Mw) of the polyester resin is preferably from 5000 to 1000000 inclusive and more preferably from 7000 to 500000 inclusive.

The number average molecular weight (Mn) of the polyester resin may be from 2000 to 100000 inclusive.

The molecular weight distribution Mw/Mn of the polyester resin is preferably from 1.5 to 100 inclusive and more preferably from 2 to 60 inclusive.

The weight average molecular weight and the number average molecular weight are measured by gel permeation chromatography (GPC). In the molecular weight measurement by GPC, a GPC measurement apparatus HLC-8120GPC manufactured by TOSOH Corporation is used. A TSKgel Super HM-M (15 cm) column manufactured by TOSOH Corporation is used, and a THF solvent is used. The weight average molecular weight and the number average molecular weight are computed from the measurement results using a molecular weight calibration curve produced using monodispersed polystyrene standard samples.

The polyester resin is obtained by a well-known production method. Specifically, the polyester resin is obtained, for example, by the following method. The polymerization temperature is set to from 180° C. to 230° C. inclusive. If necessary, the pressure inside the reaction system is reduced, and the reaction is allowed to proceed while water and alcohol generated during condensation are removed.

When the raw material monomers are not dissolved or not compatible with each other at the reaction temperature, a high-boiling point solvent may be added as a solubilizer to dissolve the monomers. In this case, the polycondensation reaction is performed while the solubilizer is removed by evaporation. When a monomer with poor compatibility is present, the monomer with poor compatibility and an acid or an alcohol to be polycondensed with the monomer are condensed in advance, and then the resulting polycondensation product and the rest of the components are subjected to polycondensation.

The content of the binder resin with respect to the total mass of the toner particles is preferably from 40% by mass to 95% by mass inclusive, more preferably from 50% by mass to 90% by mass inclusive, and still more preferably from 60% by mass to 85% by mass inclusive.

### —Coloring Agent—

Examples of the coloring agent include: pigments such as carbon black, chrome yellow, Hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; dyes such as acridine-based dyes, xanthene-based dyes, azo-based dyes, benzoquinone-based dyes, azine-based dyes, anthraquinone-based dyes, thioindigo-based dyes, dioxazine-based dyes, thiazine-based dyes, azomethine-based dyes, indigo-based dyes, phthalocyanine-based dyes, aniline black-based dyes, polymethine-based dyes, triphenylmethane-based dyes, diphenylmethane-based dyes, and thiazole-based dyes; and inorganic pigments such as titanium compounds and silica.

The coloring agent is not limited to a material having absorption in the visible range. The coloring agent may be a material having absorption in the near-infrared range or may be a fluorescent coloring agent.

Examples of the coloring agent having absorption in the near-infrared range include aluminum salt-based compounds, naphthalocyanine-based compounds, squarylium-based compounds, and croconium-based compounds.

Examples of the fluorescent coloring agent include fluorescent coloring agents described in paragraph 0027 in Japanese Unexamined Patent Application Publication No. 2021-127431.

The coloring agent may be a brilliant coloring agent. Examples of the brilliant coloring agent include powders of metals such as aluminum, brass, bronze, nickel, stainless steel, and zinc; mica coated with titanium oxide or yellow iron oxide; coated flake-like inorganic crystalline substances such as barium sulfate, lamellar silicates, and silicates of lamellar aluminum; monocrystalline plate-like titanium oxide; basic carbonates; bismuth oxychloride; natural guanine; flake-like glass powders; and metal-deposited flake-like glass powders.

One of the coloring agents may be used alone, or two or more of them may be used in combination.

The coloring agent used may be optionally subjected to surface treatment or may be used in combination with a dispersant.

In the present exemplary embodiment, the toner particles may contain the coloring agent or may contain no coloring agent. The toner according to the present exemplary embodiment may be a toner including toner particles containing no coloring agent, i.e., a so-called transparent toner.

In the present exemplary embodiment, when the toner particles contain no coloring agent, the toner according to the present exemplary embodiment has the effect of reducing the occurrence of variations in gloss and/or lightness of images formed using the toner.

In the present exemplary embodiment, when the toner particles contain the coloring agent, the content of the coloring agent is preferably from 1% by mass to 30% by mass inclusive and more preferably from 3% by mass to 15% by mass inclusive based on the total mass of the toner particles.

### —Release Agent—

Examples of the release agent include: hydrocarbon-based waxes; natural waxes such as carnauba wax, rice wax, and candelilla wax; synthetic and mineral/petroleum-based waxes such as montan wax; and ester-based waxes such as fatty acid esters and montanic acid esters. The release agent used is not limited to the above release agents.

The melting temperature of the release agent is preferably from 50° C. to 110° C. inclusive and more preferably from 60° C. to 100° C. inclusive.

The melting temperature is determined using a DSC curve obtained by differential scanning calorimetry (DSC) from “peak melting temperature” described in melting temperature determination methods in “Testing methods for transition temperatures of plastics” in JIS K7121-1987.

The content of the release agent with respect to the total mass of the toner particles is preferably from 1% by mass to 20% by mass inclusive and more preferably from 5% by mass to 15% by mass inclusive.

### —Additional Additives—

Examples of the additional additives include well-known additives such as a magnetic material, a charge control agent, and an inorganic powder. These additives are contained in the toner particles as internal additives.

### —Characteristics Etc. of Toner Particles—

The toner particles may have a single layer structure or may have a so-called core-shell structure including a core (core particle) and a coating layer (shell layer) covering the core.

Toner particles having the core-shell structure may each include, for example: a core containing a binder resin and optional additives such as a coloring agent and a release agent; and a coating layer containing a binder resin.

The volume average particle diameter (D50v) of the toner particles is preferably from 2 μm to 10 μm inclusive and more preferably from 4 μm to 8 μm inclusive.

Average particle diameters and particle size distribution indexes of the toner particles are measured using Coulter Multisizer II (manufactured by Beckman Coulter, Inc.), and ISOTON-II (manufactured by Beckman Coulter, Inc.) is used as an electrolyte.

In the measurement, 0.5 mg to 50 mg of a measurement sample is added to 2 mL of a 5% aqueous solution of a surfactant (which may be sodium alkylbenzenesulfonate) serving as a dispersant. The mixture is added to 100 mL to 150 mL of the electrolyte.

The electrolyte with the sample suspended therein is subjected to dispersion treatment for 1 minute using an ultrasonic dispersion apparatus, and then the particle size distribution of particles having diameters within the range of 2 μm to 60 μm is measured using an aperture having an aperture diameter of 100 μm in the Coulter Multisizer II. The number of particles sampled is 50000.

The particle size distribution measured and divided into particle size ranges (channels) is used to obtain volume-based and number-based cumulative distributions computed from the small diameter side. In the computed volume-based cumulative distribution, the particle diameter at a cumulative frequency of 16% is defined as a volume-based particle diameter D16v, and the particle diameter at a cumulative frequency of 50% is defined as a volume average particle diameter D50v. The particle diameter at a cumulative frequency of 84% is defined as a volume-based particle diameter D84v. In the number-based cumulative distribution, the particle diameter at a cumulative frequency of 16% is defined as a number-based particle diameter D16p, and the particle diameter at a cumulative frequency of 50% is defined as a number average cumulative particle diameter D50p. Moreover, the particle diameter at a cumulative frequency of 84% is defined as a number-based particle diameter D84p.

These are used to compute a volume-based particle size distribution index (GSDv) defined as (D84v/D16v)^{1/2} and a number-based particle size distribution index (GSDp) defined as (D84p/D16p)^{1/2}.

The average circularity of the toner particles is preferably from 0.94 to 1.00 inclusive and more preferably from 0.95 to 0.98 inclusive.

The circularity of a toner particle is determined as (the peripheral length of an equivalent circle of the toner particle)/(the peripheral length of the toner particle) (i.e., the peripheral length of a circle having the same area as a projection image of the particle/the peripheral length of the projection image of the particle). Specifically, the average circularity is a value measured by the following method.

First, the toner particles used for the measurement are collected by suction, and a flattened flow of the particles is formed. Particle images are captured as still images using flashes of light, and the average circularity is determined by subjecting the particle images to image analysis using a flow-type particle image analyzer (FPIA-3000 manufactured by SYSMEX Corporation). The number of sampled particles for the determination of the average circularity is 3,500.

When the toner contains the external additives, the toner (developer) for the measurement is dispersed in water containing a surfactant, and the dispersion is subjected to ultrasonic treatment. The toner particles with the external additives removed are thereby obtained.

### [Perovskite Compound Particles]

The perovskite compound particles may have an average primary particle diameter of from 10 nm to 100 nm inclusive. When the average primary particle diameter of the perovskite compound particles is 10 nm or more, the perovskite compound particles are unlikely to be embedded in the toner particles. When the average primary particle diameter of the perovskite compound particles is 100 nm or less, the perovskite compound particles tend to be highly uniformly dispersed on the surfaces of the toner particles.

From the above point of view, the average primary particle diameter of the perovskite compound particles is preferably from 10 nm to 100 nm inclusive, more preferably from 20 nm to 90 nm inclusive, still more preferably from 30 nm to 80 nm inclusive, and particularly preferably from 30 nm to 60 nm inclusive.

In the present exemplary embodiment, the primary particle diameters of the perovskite compound particles are the diameters of circles having the same areas as their corresponding primary particle images (so-called equivalent circle diameters), and the average primary particle diameter of the perovskite compound particles is the particle diameter at which a cumulative frequency cumulated from the small diameter side in a number-based primary particle diameter distribution is 50%. The primary particle diameters of the perovskite compound particles are determined as follows. An electron microscope image of the toner containing the perovskite compound particles externally added thereto is taken, and images of at least 300 perovskite compound particles on toner particles are analyzed.

The average primary particle diameter of the perovskite compound particles can be controlled, for example, by changing various conditions used when the perovskite compound particles are produced by a wet production method.

Examples of the perovskite compound particles include: alkaline-earth metal titanate particles such as magnesium titanate particles, calcium titanate particles, strontium titanate particles, and barium titanate particles; and alkaline-earth metal zirconate particles such as magnesium zirconate particles, calcium zirconate particles, strontium zirconate particles, and barium zirconate particles. One type of perovskite compound particles may be used alone, or two or more types may be used in combination.

The crystal structure of the perovskite compound particles is a perovskite structure, and the particles generally have a cubic or cuboidal shape. In the present exemplary embodiment, the perovskite compound particles may have a rounded shape rather than a cubic or cuboidal shape. The rounded shape can be obtained by doping the perovskite compound particles with a dopant.

From the viewpoint of preventing the reduction in the amount of charges when the toner is subjected to an electric field, the perovskite compound particles are preferably alkaline-earth metal titanate particles, more preferably strontium titanate particles, still more preferably strontium titanate particles doped with a metal element (dopant) other than titanium and strontium, and particularly preferably strontium titanate particles doped with lanthanum. The strontium titanate particles in the present exemplary embodiment will be described in detail.

### [Strontium Titanate Particles]

The content of the strontium titanate particles is preferably from 0.2 parts by mass to 3.0 parts by mass inclusive, more preferably from 0.5 parts by mass to 2.5 parts by mass inclusive, and still more preferably from 1.0 part by mass to 2.0 parts by mass inclusive, based on 100 parts by mass of the toner particles.

The mass percentage of the silica particles (S) with respect to the total mass of the strontium titanate particles and the silica particles (S) is preferably from 40% by mass to 60% by mass inclusive and more preferably from 45% by mass to 55% by mass inclusive.

From the viewpoint of allowing the strontium titanate particles and the silica particles (S) to be well mixed and dispersed on the surfaces of the toner particles, the ratio D2/D1 of the average primary particle diameter D2 of the silica particles (S) to the average primary particle diameter D1 of the perovskite compound particles is preferably from 0.45 to 2.00 inclusive, more preferably from 0.50 to 1.70 inclusive, and still more preferably from 0.75 to 1.50 inclusive.

The strontium titanate particles may have an average primary particle diameter of from 10 nm to 100 nm inclusive. When the average primary particle diameter of the strontium titanate particles is 10 nm or more, the strontium titanate particles are unlikely to be embedded in the toner particles. When the average primary particle diameter of the strontium titanate particles is 100 nm or less, the strontium titanate particles tend to be highly uniformly dispersed on the surfaces of the toner particles.

From the above point of view, the average primary particle diameter of the strontium titanate particles is preferably from 10 nm to 100 nm inclusive, more preferably from 20 nm to 90 nm inclusive, still more preferably from 30 nm to 80 nm, inclusive and yet more preferably from 30 nm to 60 nm inclusive.

In the present exemplary embodiment, the primary particle diameters of the strontium titanate particles are the diameters of circles having the same areas as their corresponding primary particle images (so-called equivalent circle diameters), and the average primary particle diameter of the strontium titanate particles is the particle diameter at which a cumulative frequency cumulated from the small diameter side in a number-based primary particle diameter distribution is 50%. The primary particle diameters of the strontium titanate particles are determined as follows. An electron microscope image of the toner containing the strontium titanate particles externally added thereto is taken, and images of at least 300 strontium titanate particles on toner particles are analyzed. A specific measurement method will be described later in [Examples].

The average primary particle diameter of the strontium titanate particles can be controlled, for example, by changing various conditions used when the strontium titanate particles are produced by a wet production method.

The crystal structure of the strontium titanate particles is a perovskite structure, and the particles generally have a cubic or cuboidal shape. In the present exemplary embodiment, the perovskite compound particles may have a rounded shape rather than a cubic or cuboidal shape because of the following reasons 1 and 2. The rounded shape can be obtained by doping the strontium titanate particles with a metal element (dopant) other than titanium and strontium.

Reason 1: When the strontium titanate particles have a rounded shape, they tend to be highly uniformly dispersed on the surfaces of the toner particles.

Reason 2: When the strontium titanate particles have a cubic or cuboidal shape, i.e., have vertices, charges are concentrated at the vertices. In this case, large electrostatic repulsive force is locally generated between the vertices of the strontium titanate particles and the silica particles (S), and this may cause segregation of the silica particles (S). To prevent the segregation of the silica particles (S), the strontium titanate particles may have a shape with less sharp edges, i.e., a rounded shape.

The half width of a (110) peak of the strontium titanate particles that is obtained by X-ray diffraction is preferably from 0.2° to 2.0° inclusive and more preferably from 0.2° to 1.0° inclusive.

The (110) peak of the strontium titanate particles that is obtained by X-ray diffraction is a peak present around a diffraction angle 2θ of 32°. This peak corresponds to a (110) peak of a perovskite crystal.

Strontium titanate particles having a cubic or cuboidal shape have a high degree of perovskite crystallinity, and the half width of the (110) peak is generally less than 0.2°. For example, when the SW-350 manufactured by Titan Kogyo, Ltd. (strontium titanate particles mostly having a cubic shape) is analyzed, the half width of the (110) peak is 0.15°.

Strontium titanate particles having a rounded shape have a lower degree of perovskite crystallinity, and the half width of the (110) peak is large.

The strontium titanate particles may have a rounded shape. The half width of the (110) peak, which is an indicator of the rounded shape, is preferably from 0.2° to 2.0° inclusive, more preferably from 0.2° to 1.0° inclusive, and still more preferably from 0.2° to 0.5° inclusive.

The strontium titanate particles are subjected to X-ray diffraction measurement using an X-ray diffraction apparatus (e.g., product name: RINT Ultima-III manufactured by Rigaku Corporation). The following measurement settings are used: X-ray source: CuKα; voltage: 40 kV; current: 40 mA; sample rotation speed: no rotation; divergence slit: 1.00 mm; vertical divergence limiting slit: 10 mm; scattering slit: open; receiving slit: open; scan mode: FT; counting time: 2.0 seconds; step width: 0.0050°; and operation axis: 10.00000 to 70.0000°. In the present exemplary embodiment of the disclosure, the half width of a peak in an X-ray diffraction pattern is a full width at half maximum.

The strontium titanate particles may be doped with a metal element (dopant) other than titanium and strontium. When the strontium titanate particles contain a dopant, the degree of crystallinity of the perovskite structure decreases, and a rounded shape is obtained.

No particular limitation is imposed on the dopant for the strontium titanate particles, so long as it is a metal element other than titanium and strontium. One dopant may be used alone, or two or more dopants may be used in combination.

The dopant for the strontium titanate particles may be a metal element that, when ionized, has an ionic radius allowing the metal element to enter the crystal structure of the strontium titanate particles. From this point of view, the dopant for the strontium titanate particles is preferably a metal element that, when ionized, has an ionic radius of from 40 pm to 200 pm inclusive and more preferably a metal element that, when ionized, has an ionic radius of from 60 pm to 150 pm inclusive.

Specific examples of the dopant for the strontium titanate particles include lanthanoids, silica, aluminum, magnesium, calcium, barium, phosphorus, sulfur, calcium, vanadium, chromium, manganese, iron, cobalt, nickel, copper, gallium, yttrium, zinc, niobium, molybdenum, ruthenium, rhodium, palladium, silver indium, tin, antimony, barium, tantalum, tungsten, rhenium, osmium, iridium, platinum, and bismuth. Among the lanthanoids, lanthanum or cerium may be selected. From the viewpoint of ease of doping and ease of controlling the shape of the strontium titanate particles, lanthanum may be selected.

From the viewpoint of preventing the strontium titanate particles from being negatively charged excessively, the dopant for the strontium titanate particles is preferably a metal element with an electronegativity of 2.0 or less and more preferably a metal element with an electronegativity of 1.3 or less. In the present exemplary embodiment, the electronegativity is Allred-Rochow electronegativity. Examples of the metal element with an electronegativity of 2.0 or less include lanthanum (electronegativity: 1.08), magnesium (1.23), aluminum (1.47), silica (1.74), calcium (1.04), vanadium (1.45), chromium (1.56), manganese (1.60), iron (1.64), cobalt (1.70), nickel (1.75), copper (1.75), zinc (1.66), gallium (1.82), yttrium (1.11), zirconium (1.22), niobium (1.23), silver (1.42), indium (1.49), tin (1.72), barium (0.97), tantalum (1.33), rhenium (1.46), and cerium (1.06).

From the viewpoint of allowing the strontium titanate particles to have a rounded shape while the perovskite crystal structure is maintained, the amount of the dopant in the strontium titanate particles with respect to the amount of strontium is preferably within the range of from 0.1% by mole to 20% by mole inclusive, more preferably within the range of from 0.1% by mole to 10% by mole inclusive, and still more preferably within the range of from 0.2% by mole to 5% by mole inclusive.

From the viewpoint of improving the effect of the strontium titanate particles, the strontium titanate particles are preferably strontium titanate particles each having a surface subjected to hydrophobization treatment and more preferably strontium titanate particles each having a surface subjected to hydrophobization treatment with a silicon-containing organic compound.

The strontium titanate particles each have a surface containing the silicon-containing organic compound in an amount of preferably from 1% by mass to 50% by mass inclusive with respect to the mass of the particle (more preferably from 5% by mass to 40% by mass inclusive, still more preferably from 5% by mass to 30% by mass inclusive, and yet more preferably from 10% by mass to 25% by mass inclusive).

Specifically, the amount of the silicon-containing organic compound used for the hydrophobization treatment with respect to the mass of the strontium titanate particles is preferably from 1% by mass to 50% by mass inclusive, more preferably from 5% by mass to 40% by mass inclusive, still more preferably from 5% by mass to 30% by mass inclusive, and yet more preferably from 10% by mass to 25% by mass inclusive.

From the viewpoint of improving the effect of the strontium titanate particles, the mass ratio Si/Sr of silicon (Si) to strontium (Sr) on the surfaces of the strontium titanate particles subjected to the hydrophobization treatment with the silicon-containing organic compound is preferably from 0.025 to 0.25 inclusive and more preferably from 0.05 to 0.20 inclusive. The mass ratio Si/Sr is computed by X-ray fluorescence qualitative and quantitative analysis.

The X-ray fluorescence analysis on the hydrophobic-treated surfaces of the strontium titanate particles is performed by the following method.

An X-ray fluorescence analyzer (XRF1500 manufactured by Shimadzu Corporation) is used to perform the qualitative and quantitative analysis under the following conditions: X-ray output power: 40 V/70 mA; measurement area: 10 mm in diameter; and measurement time: 15 minutes. Elements analyzed are oxygen (O), silicon (Si), titanium (Ti), strontium (Sr), and other metal elements (Me). Calibration curve data produced separately is used to compute the mass ratio (%) of each element. The mass ratio of silicon (Si) and the mass ratio of strontium (Sr) obtained by the measurement are used to compute the mass ratio Si/Sr.

The common logarithm of the specific volume resistivity R (Ω·cm) of the strontium titanate particles, i.e., log R, is preferably from 11 to 14 inclusive, more preferably from 11 to 13 inclusive, and still more preferably from 12 to 13 inclusive.

The specific volume resistivity R of the strontium titanate particles can be controlled, for example, by changing the type of dopant, the amount of the dopant, the type of hydrophobizing agent, the amount of the hydrophobizing agent, the temperature and time of drying after the hydrophobization treatment, etc.

The specific volume resistivity R of the strontium titanate particles is measured as follows.

A pair of 20-cm² circular electrode plates (made of steel) connected to an electrometer (KEITHLEY 610C manufactured by KEITHLEY) and a high-voltage power supply (FLUKE 415B manufactured by FLUKE) are used as measurement jigs. The strontium titanate particles are placed on a lower one of the electrode plates so as to form a flat layer with a thickness in the range of from 1 mm to 2 mm inclusive. Then the strontium titanate particles are subjected to humidity control in an environment with a temperature of 22° C. and a relative humidity of 55% for 24 hours. Next, the upper electrode plate is disposed on the strontium titanate particle layer in an environment with a temperature of 22° C. and a relative humidity of 55%. A weight of 4 kg is placed on the upper electrode plate to eliminate pore in the strontium titanate particle layer, and the thickness of the strontium titanate particle layer in this state is measured. Next, a voltage of 1,000 V is applied between the electrode plates, and a current value is measured. The specific volume resistivity R is computed from the following formula (1):

specific volume resistivity R(Ω·cm)=V×S/(A1−A0)/d Formula (1):

In formula (1), V is the applied voltage (1,000 V); S is the area of the electrode plates (20 cm²); A1 is the current value measured (A); A0 is an initial current value (A) when the applied voltage is 0 V; and d is the thickness (cm) of the strontium titanate particle layer.

The water content of the strontium titanate particles may be from 1.5% by mass to 10% by mass inclusive. When the water content is from 1.5% by mass to 10% by mass inclusive (more preferably from 2% by mass to 5% by mass inclusive), the electric resistance of the strontium titanate particles is controlled within an appropriate range, and uneven distribution may be prevented because of electrostatic repulsion between the strontium titanate particles. The water content of the strontium titanate particles may be controlled, for example, by producing the strontium titanate particles by a wet production method while the temperature and time of drying treatment are adjusted. When the strontium titanate particles are subjected to hydrophobization treatment, the water content of the strontium titanate particles may be controlled by adjusting the temperature and time of drying treatment performed after the hydrophobization treatment.

The water content of the strontium titanate particles is measured as follows. 20 mg of the measurement sample is placed in a chamber at a temperature of 22° C. and a relative humidity of 55% and left to stand for 17 hours to subject the sample to humidity control. Then, in the interior of a room at a temperature of 22° C. and a relative humidity of 55%, the sample is heated in a nitrogen atmosphere from 30° C. to 250° C. at a temperature increase rate of 30° C./minute using a thermo-balance (Type TGA-50 manufactured by Shimadzu Corporation) to thereby measure the loss on heating (the mass loss on heating).

The water content is computed from the measured loss on heating using the following equation.

Water content (% by mass)=(loss on heating from 30° C. to 250° C.)/(mass after humidity control but before heating)×100

### [Method for Producing Strontium Titanate Particles]

The strontium titanate particles may be untreated strontium titanate particles or may be particles prepared by subjecting the surfaces of the strontium titanate particles to hydrophobization treatment. No particular limitation is imposed on the method for producing the strontium titanate particles. From the viewpoint of controlling the diameter and shape of the particles, the production method may be a wet production method.

In the wet production method for the strontium titanate particles, for example, a solution mixture of a titanium oxide source and a strontium source is allowed to react while an aqueous alkali solution is added thereto, and then the product is subjected to acid treatment. In this production method, the diameter of the strontium titanate particles is controlled by changing the mixing ratio of the strontium source to the titanium oxide source, the concentration of the titanium oxide source at the beginning of the reaction, the temperature when the aqueous alkali solution is added, the addition rate of the aqueous alkali solution, etc.

The titanium oxide source used may be a peptized product prepared by peptizing a hydrolysate of a titanium compound with a mineral acid. Examples of the strontium source include strontium nitrate and strontium chloride.

As for the mixing ratio of the strontium source to the titanium oxide source, the molar ratio SrO/TiO₂ is preferably from 0.9 to 1.4 inclusive and more preferably from 1.05 to 1.20 inclusive. As for the concentration of the titanium oxide source at the beginning of the reaction, the concentration of TiO₂ is preferably from 0.05 mol/L to 1.3 mol/L inclusive and more preferably from 0.5 mol/L to 1.0 mol/L inclusive.

From the viewpoint of forming the strontium titanate particles into a rounded shape rather than cubic and cuboidal shapes, a dopant source may be added to the solution mixture of the titanium oxide source and the strontium source. Examples of the dopant source include oxides of metals other than titanium and strontium. The metal oxide used as the dopant source is added, for example, in the form of a solution in nitric acid, hydrochloric acid, or sulfuric acid. As for the amount of the dopant source added, the amount of the metal contained in the dopant source with respect to 100 moles of strontium contained in the strontium source is preferably from 0.1 moles to 20 moles inclusive, more preferably from 0.1 moles to 10 moles inclusive, and still more preferably from 0.2 moles to 5 moles inclusive.

The aqueous alkali solution may be an aqueous sodium hydroxide solution. The higher the temperature of a reaction solution when the aqueous alkali solution is added, the better the crystallinity of the strontium titanate particles obtained. From the viewpoint of obtaining a rounded shape while the perovskite crystal structure is maintained, the temperature of the reaction solution when the aqueous alkali solution is added may be within the range of from 60° C. to 100° C. inclusive. The lower the rate of addition of the aqueous alkali solution, the larger the diameter of the strontium titanate particles obtained. The higher the rate of addition, the smaller the diameter of the strontium titanate particles obtained. The rate of addition of the aqueous alkali solution with respect to the raw materials is, for example, from 0.001 equivalents/h to 1.2 equivalents/h inclusive and suitably from 0.002 equivalents/h to 1.1 equivalents/h inclusive.

After the addition of the aqueous alkali solution, acid treatment is performed for the purpose of removing an unreacted portion of the strontium source. The acid treatment is performed using, for example, hydrochloric acid to adjust the pH of the reaction solution to 2.5 to 7.0 and preferably 4.5 to 6.0. After the acid treatment, the reaction solution is subjected to solid-liquid separation, and the solid is dried to thereby obtain the strontium titanate particles.

The strontium titanate particles are subjected to surface treatment, for example, in the following manner. The silicon-containing organic compound serving as a hydrophobizing agent and a solvent are mixed to prepare a treatment solution. Then the strontium titanate particles and the treatment solution are mixed under stirring, and then the stirring is continued. After the surface treatment, drying treatment is performed for the purpose of removing the solvent in the treatment solution.

Examples of the silicon-containing organic compound used for the surface treatment of the strontium titanate particles include alkoxysilane compounds, silazane compounds, and silicone oils.

Examples of the alkoxysilane compound used for the surface treatment of the strontium titanate particles include tetramethoxysilane, tetraethoxysilane, methyltrimethoxysilane, ethyltrimethoxysilane, propyltrimethoxysilane, butyltrimethoxysilane, hexyltrimethoxysilane, n-octyltrimethoxysilane, decyltrimethoxysilane, dodecyltrimethoxysilane, vinyltriethoxysilane, methyltriethoxysilane, ethyltriethoxysilane, butyltriethoxysilane, hexyltriethoxysilane, decyltriethoxysilane, dodecyltriethoxysilane, phenyltrimethoxysilane, o-methylphenyltrimethoxysilane, p-methylphenyltrimethoxysilane, phenyltriethoxysilane, benzyltriethoxysilane, dimethyldimethoxysilane, dimethyldiethoxysilane, methylvinyldimethoxysilane, methylvinyldiethoxysilane, diphenyldimethoxysilane, diphenyldiethoxysilane, trimethylmethoxysilane, and trimethylethoxysilane.

Examples of the silazane compound used for the surface treatment of the strontium titanate particles include dimethyldisilazane, trimethyldisilazane, tetramethyldisilazane, pentamethyldisilazane, and hexamethyldisilazane.

Examples of the silicone oil used for the surface treatment of the strontium titanate particles include: silicone oils such as dimethylpolysiloxane, diphenylpolysiloxane, and phenylmethylpolysiloxane; and reactive silicone oils such as amino-modified polysiloxanes, epoxy-modified polysiloxanes, carboxyl-modified polysiloxanes, carbinol-modified polysiloxanes, fluorine-modified polysiloxanes, methacrylic-modified polysiloxanes, mercapto-modified polysiloxanes, and phenol-modified polysiloxanes.

When the silicon-containing organic compound is the alkoxysilane compound or the silazane compound, the solvent used to prepare the treatment solution may be an alcohol (such as methanol, ethanol, propanol, or butanol). When the silicon-containing organic compound is the silicone oil, the solvent may be a hydrocarbon (such as benzene, toluene, n-hexane, or n-heptane).

In the treatment solution, the concentration of the silicon-containing organic compound is preferably from 1% by mass to 50% by mass inclusive, more preferably from 5% by mass to 40% by mass inclusive, and still more preferably from 10% by mass to 30% by mass inclusive.

The amount of the silicon-containing organic compound used for the surface treatment is preferably from 1 part by mass to 50 parts by mass inclusive, more preferably from 5 parts by mass to 40 parts by mass inclusive, and still more preferably from 5 parts by mass to 30 parts by mass inclusive based on 100 parts by mass of the strontium titanate particles.

### [Silica Particles (S)]

The silica particles (S) include an elemental nitrogen-containing compound containing elemental molybdenum, and the ratio N_{Mo}/N_{Si} of the Net intensity N_{Mo} of elemental molybdenum measured by X-ray fluorescence analysis to the Net intensity N_{Si} of elemental Si measured by the X-ray fluorescence analysis is from 0.035 to 0.45 inclusive.

The “elemental nitrogen-containing compound containing elemental molybdenum” is hereinafter referred to as a “molybdenum/nitrogen-containing compound.”

From the viewpoint of narrowing the charge distribution and retainability of the charge distribution, the Net intensity N_{Mo} of elemental molybdenum in the silica particles (S) is preferably from 5 kcps to 75 kcps inclusive, more preferably from 7 kcps to 55 kcps inclusive, still more preferably from 8 kcps to 50 kcps inclusive, and yet more preferably from 10 kcps to 40 kcps inclusive.

The Net intensity N_{Mo} of elemental molybdenum and the Net intensity N_{Si} of elemental silicon in the silica particles are measured by the following method.

About 0.5 g of the silica particles are compressed under a load of 6 t for 60 seconds using a compression molding machine to produce a disk with a diameter of 50 mm and a thickness of 2 mm. This disk is used as a sample, and qualitative and quantitative elemental analysis is performed under the following conditions using a scanning X-ray fluorescence analyzer (XRF-1500 manufactured by Shimadzu Corporation) to thereby determine the Net intensities of elemental molybdenum and elemental silicon (unit: kilo counts per second, kcps).
Tube voltage: 40 kV
Tube current: 90 mA
Measurement area (analysis diameter): diameter 10 mm
Measurement time: 30 minutes
Anticathode: rhodium

The silica particles (S) contain the molybdenum/nitrogen-containing compound. An exemplary structure of the silica particles (S) will be described.

In one exemplary embodiment of the silica particles (S), at least part of the surfaces of silica base particles are coated with a reaction product of a silane coupling agent, and the molybdenum/nitrogen-containing compound adheres to the coating structure of the reaction product. In the present exemplary embodiment, a hydrophobic-treated structure (a structure obtained by treating the silica particles with a hydrophobizing agent) may further adheres to the coating structure of the reaction product. The silane coupling agent is preferably at least one selected from the group consisting of a monofunctional silane coupling agent, a bifunctional silane coupling agent, and a trifunctional silane coupling agent and is more preferably a trifunctional silane coupling agent.

### —Silica Base Particles—

The silica base particles may be dry silica or may be wet silica.

Examples of the dry silica include: combustion method silica (fumed silica) obtained by combusting a silane compound; and deflagration method silica obtained by explosively combusting a metal silicon powder.

Examples of the wet silica include: wet silica obtained through a neutralization reaction of sodium silicate and a mineral acid (precipitated silica synthesized and aggregated under alkaline conditions and gel method silica particles synthesized and aggregated under acidic conditions); colloidal silica obtained by alkalifying and polymerizing acidic silicate; and sol-gel silica obtained by hydrolysis of an organic silane compound (e.g., alkoxysilane). From the viewpoint of narrowing the charge distribution, the silica base particles may be sol-gel silica.

### —Reaction Product of Silane Coupling Agent—

The structure formed from the reaction product of the silane coupling agent (in particular, the reaction product of a trifunctional silane coupling agent) includes a pore structure and has a high affinity for the molybdenum/nitrogen-containing compound. Therefore, the molybdenum/nitrogen-containing compound penetrates deep into the pores, and the amount of the molybdenum/nitrogen-containing compound contained in the silica particles (S) is relatively large.

The surfaces of the silica base particles are negatively chargeable. When the positively chargeable molybdenum/nitrogen-containing compound adheres to the surfaces of the silica base particles, the effect of cancelling excessive negative charges on the silica base particles is generated. Since the molybdenum/nitrogen-containing compound adheres not to the outermost surfaces of the silica particles (S) but to the inside of the coating structure (i.e., the pore structure) formed from the reaction product of the silane coupling agent, the charge distribution on the silica particles (S) does not extend to the positive charge side, and excessive negative charges on the silica base particles are cancelled, so that the charge distribution on the silica particles (S) is narrowed.

The silane coupling agent may be a compound containing no N (elemental nitrogen). Examples of the silane coupling agent include a silane coupling agent represented by the following formula (TA).

R¹ₙ—Si(OR²)₄₋ₙ Formula (TA)

In formula (TA), R¹ is a saturated or unsaturated aliphatic hydrocarbon group having 1 to 20 carbon atoms or an aromatic hydrocarbon group having 6 to 20 carbon atoms, and R² is a halogen atom or an alkyl group. n is 1, 2, or 3. When n is 2 or 3, the plurality of R¹s may be the same or different. When n is 1 or 2, the plurality of R²s may be the same or different.

Examples of the reaction product of the silane coupling agent include: a reaction product in which all or part of OR²s in formula (TA) are replaced with OH groups; a reaction product in which all or part of groups with OR²s replaced with OH groups are polycondensed; and a reaction product in which all or part of groups with OR²s replaced with OH groups and SiOH groups in the silica base particles are polycondensed.

The aliphatic hydrocarbon group represented by R¹ in formula (TA) may be linear, branched, or cyclic and is preferably linear or branched. The number of carbon atoms in the aliphatic hydrocarbon group is preferably from 1 to 20 inclusive, more preferably from 1 to 18 inclusive, still more preferably from 1 to 12 inclusive, and yet more preferably from 1 to 10 inclusive. The aliphatic hydrocarbon group may be saturated or unsaturated and is preferably a saturated aliphatic hydrocarbon group and more preferably an alkyl group. Any hydrogen atom in aliphatic hydrocarbon group may be replaced with a halogen atom.

Examples of the saturated aliphatic hydrocarbon group include: linear alkyl groups (such as a methyl group, an ethyl group, a propyl group, a butyl group, a pentyl group, a hexyl group, a heptyl group, an octyl group, a nonyl group, a decyl group, a dodecyl group, a hexadecyl group, and an icosyl group); branched alkyl groups (such as an isopropyl group, an isobutyl group, an isopentyl group, a neopentyl group, a 2-ethylhexyl group, a tert-butyl group, a tert-pentyl group, and an iso-pentadecyl group); and cyclic alkyl groups (such as a cyclopropyl group, a cyclopentyl group, a cyclohexyl group, a cycloheptyl group, a cyclooctyl group, a tricyclodecyl group, a norbornyl group, and an adamantyl group).

Examples of the unsaturated aliphatic hydrocarbon group include: alkenyl groups (such as a vinyl group (ethenyl group), a 1-propenyl group, a 2-propenyl group, a 2-butenyl group, a 1-butenyl group, a 1-hexenyl group, a 2-dodecenyl group, and a pentenyl group); and alkynyl groups (such as an ethynyl group, a 1-propynyl group, a 2-propynyl group, a 1-butynyl group, a 3-hexynyl group, and a 2-dodecynyl group).

The number of carbon atoms in the aromatic hydrocarbon group represented by R¹ in formula (TA) is preferably from 6 to 20 inclusive, more preferably from 6 to 18 inclusive, still more preferably from 6 to 12 inclusive, and yet more preferably from 6 to 10 inclusive. Examples of the aromatic hydrocarbon group include a phenylene group, a biphenylene group, a terphenylene group, a naphthalene group, and an anthracene group. Any hydrogen atom in the aromatic hydrocarbon group may be replaced with a halogen atom.

Examples of the halogen atom represented by R² in formula (TA) include a fluorine atom, a chlorine atom, a bromine atom, and an iodine atom, and the halogen atom may be a chlorine atom, a bromine atom, or an iodine atom.

The alkyl group represented by R² in formula (TA) is preferably an alkyl group having 1 to 10 carbon atoms, more preferably an alkyl group having 1 to 8 carbon atoms, and still more preferably an alkyl group having 1 to 4 carbon atoms. Examples of the linear alkyl group having 1 to 10 carbon atoms include a methyl group, an ethyl group, a n-propyl group, a n-butyl group, a n-pentyl group, a n-hexyl group, a n-heptyl group, a n-octyl group, a n-nonyl group, and a n-decyl group. Examples of the branched alkyl group having 3 to 10 carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group. Examples of the cyclic alkyl group having 3 to 10 carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (e.g., bicyclic, tricyclic, and spirocyclic) alkyl groups including any of the above monocyclic alkyl groups bonded together. Any hydrogen atom in the alkyl group may be replaced with a halogen atom.

n in formula (TA) is 1, 2, or 3 and is preferably 1 or 2 and more preferably 1.

The silane coupling agent represented by formula (TA) may be a trifunctional silane coupling agent with R¹ being a saturated aliphatic hydrocarbon group having 1 to 20 carbon atoms, R² being a halogen atom or an alkyl group having 1 to 10 carbon atoms, and n being 1.

Examples of the trifunctional silane coupling agent include: vinyltrimethoxysilane, vinyltriethoxysilane, methyltrimethoxysilane, ethyltrimethoxysilane, propyltrimethoxysilane, butyltrimethoxysilane, hexyltrimethoxysilane, n-octyltrimethoxysilane, decyltrimethoxysilane, dodecyltrimethoxysilane, methyltriethoxysilane, ethyltriethoxysilane, butyltriethoxysilane, hexyltriethoxysilane, decyltriethoxysilane, dodecyltriethoxysilane, phenyltrimethoxysilane, o-methylphenyltrimethoxysilane, p-methylphenyltrimethoxysilane, phenyltriethoxysilane, benzyltriethoxysilane, decyltrichlorosilane, and phenyltrichlorosilane (these are compounds in which R¹ in formula (TA) is an unsubstituted aliphatic hydrocarbon group or an unsubstituted aromatic hydrocarbon group); and 3-glycidoxypropyltrimethoxysilane, γ-methacryloxypropyltrimethoxysilane, γ-mercaptopropyltrimethoxysilane, γ-chloropropyltrimethoxysilane, and γ-glycidyloxypropylmethyldimethoxysilane (these are compounds in which R¹ in formula (TA) is a substituted aliphatic hydrocarbon group or a substituted aromatic hydrocarbon group). Any one of these trifunctional silane coupling agents may be used alone, one or two or more of them may be used in combination.

The trifunctional silane coupling agent is preferably an alkyltrialkoxysilane and more preferably an alkyltrialkoxysilane in which R¹ in formula (TA) is an alkyl group having 1 to 20 carbon atoms (preferably 1 to 15 carbon atoms, more preferably 1 to 8 carbon atoms, still more preferably 1 to 4 carbon atoms, and particularly preferably 1 or 2 carbon atoms) and R² is an alkyl group having 1 to 2 carbon atoms.

More specifically, the silane coupling agent forming the coating structure on the surfaces of the silica base particles is preferably at least one trifunctional silane coupling agent selected from the group consisting of alkyltrimethoxysilanes and alkyltriethoxysilanes each having an alkyl group having 1 to 20 carbon atoms,
more preferably at least one trifunctional silane coupling agent selected from the group consisting of alkyltrimethoxysilanes and alkyltriethoxysilanes each having an alkyl group having 1 to 15 carbon atoms,
still more preferably at least one trifunctional silane coupling agent selected from the group consisting of alkyltrimethoxysilanes and alkyltriethoxysilanes each having an alkyl group having 1 to 8 carbon atoms,
yet more preferably at least one trifunctional silane coupling agent selected from the group consisting of alkyltrimethoxysilanes and alkyltriethoxysilanes each having an alkyl group having 1 to 4 carbon atoms, and
particularly preferably at least one trifunctional silane coupling agent selected from the group consisting of methyltrimethoxysilane, ethyltrimethoxysilane, methyltriethoxysilane, and ethyltriethoxysilane.

The amount of the coating structure formed from the reaction product of the silane coupling agent is preferably from 5.5% by mass to 30% by mass inclusive and more preferably from 7% by mass to 22% by mass inclusive based on the total mass of the silica particles (S).

### —Molybdenum/Nitrogen-Containing Compound—

The molybdenum/nitrogen-containing compound is an elemental nitrogen-containing compound containing elemental molybdenum, but excluding ammonia and compounds in gas form at a temperature of 25° C. or lower.

The molybdenum/nitrogen-containing compound may adhere to the inside of the coating structure formed from the reaction product of the silane coupling agent (i.e., the inner side of the pores in the pore structure). One molybdenum/nitrogen-containing compound may be used, or two or more molybdenum/nitrogen-containing compounds may be used.

From the viewpoint of narrowing the charge distribution and retainability of the charge distribution, the molybdenum/nitrogen-containing compound may be at least one selected from the group consisting of quaternary ammonium salts containing elemental molybdenum (particularly, molybdic acid quaternary ammonium salts) and mixtures containing a quaternary ammonium salt and a metal oxide containing elemental molybdenum. In the quaternary ammonium salt containing elemental molybdenum, the bond between an anion containing elemental molybdenum and a cation containing quaternary ammonium is strong, and therefore this quaternary ammonium salt has high charge distribution retainability.

The molybdenum/nitrogen-containing compound may be a compound represented by formula (1) below.

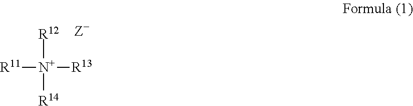

In formula (1), R¹, R², R³, and R⁴ each independently represent a hydrogen atom, an alkyl group, an aralkyl group, or an aryl group, and X⁻ represents a negative ion containing elemental molybdenum. However, at least one of R¹, R², R³, and R⁴ represents an alkyl group, an aralkyl group, or an aryl group. Two or more of R¹, R², R³, and R⁴ may be bonded together to form an aliphatic ring, an aromatic ring, or a heterocycle. The alkyl group, the aralkyl group, and the aryl group may each have a substituent.

Examples of the alkyl groups represented by R¹ to R⁴ include linear alkyl groups having 1 to 20 carbon atoms and branched alkyl groups having 3 to 20 carbon atoms. Examples of the linear alkyl group having 1 to 20 carbon atoms include a methyl group, an ethyl group, a n-propyl group, a n-butyl group, a n-pentyl group, a n-hexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, and a n-hexadecyl group. Examples of the branched alkyl group having 3 to 20 carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

The alkyl groups represented by R¹ to R⁴ may each be an alkyl group having 1 to 15 carbon atoms such as a methyl group, an ethyl group, a butyl group, or a tetradecyl group.

Examples of the aralkyl groups represented by R¹ to R⁴ include aralkyl groups having 7 to 30 carbon atoms. Examples of the aralkyl group having 7 to 30 carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracylmethyl group, and a phenyl-cyclopentylmethyl group.

The aralkyl groups represented by R¹ to R⁴ may each be an aralkyl group having 7 to 15 carbon atoms such as a benzyl group, a phenylethyl group, a phenylpropyl group, or a 4-phenylbutyl group.

Examples of the aryl groups represented by R¹ to R⁴ include aryl groups having 6 to 20 carbon atoms. Examples of the aryl group having 6 to 20 carbon atoms include a phenyl group, a pyridyl group, and a naphthyl group.

The aryl groups represented by R¹ to R⁴ may each be an aryl group having 6 to 10 carbon atoms such as a phenyl group.

Examples of the ring formed by bonding two or more of R¹, R², R³, and R⁴ together include alicycles having 2 to 20 carbon atoms and heterocyclic amines having 2 to 20 carbon atoms.

R¹, R², R³, and R⁴ may each independently have a substituent. Examples of the substituent include a nitrile group, a carbonyl group, an ether group, an amido group, a siloxane group, a silyl group, and a silane alkoxy group.

R¹, R², R³, and R⁴ may each independently represent an alkyl group having 1 to 16 carbon atoms, an aralkyl group having 7 to 10 carbon atoms, or an aryl group having 6 to 20 carbon atoms.

The negative ion containing elemental molybdenum and represented by X⁻ is preferably a molybdic acid ion, preferably a molybdic acid ion with molybdenum being tetravalent or hexavalent, and more preferably a molybdic acid ion with molybdenum being hexavalent. Specifically, the molybdic acid ion may be MoO₄²⁻, Mo₂O₇²⁻, Mo₃O₁₀²⁻, Mo₄O₁₃²⁻, Mo₇O₂₄²⁻, or Mo₈O₂₆⁴⁻.

From the viewpoint of narrowing the charge distribution and retainability of the charge distribution, the total number of carbon atoms in the compound represented by formula (1) is preferably from 18 to 35 inclusive and more preferably from 20 to 32 inclusive.

Examples of the compound represented by formula (1) are shown below. However, the present exemplary embodiment is not limited thereto.

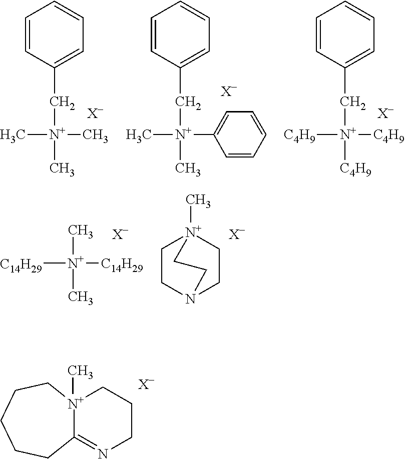

Examples of the quaternary ammonium salt containing elemental molybdenum include molybdic acid quaternary ammonium salts such as [N⁺(CH)₃(Cl₄C₂₉)₂]₄Mo₈O₂₈⁴⁻, [N⁺(C₄H₉)₂(C₆H₆)₂]₂Mo₂O₇²⁻, [N⁺(CH₃)₂(CH₂C₆H₆)(CH₂)₁₇CH₃]₂MoO₄²⁻, and [N⁺(CH₃)₂(CH₂C₆H₆)(CH₂)₁₅CH₃]₂MoO₄²⁻.

Examples of the metal oxide containing elemental molybdenum include molybdenum oxides (molybdenum trioxide, molybdenum dioxide, and Mo₉O₂₆), alkali metal molybdates (lithium molybdate, sodium molybdate, and potassium molybdate), alkaline-earth metal molybdates (magnesium molybdate and calcium molybdate), and other complex oxides (such as Bi₂O₃·2MoO₃ and γ-Ce₂Mo₃O1₃).

When the silica particles (S) are heated in the temperature range of from 300° C. to 600° C. inclusive, the molybdenum/nitrogen-containing compound is detected. The molybdenum/nitrogen-containing compound can be detected when heated at from 300° C. to 600° C. inclusive in an inert gas and is detected, for example, using a drop-type pyrolysis gas chromatography mass spectrometer of the heating furnace type using He as a carrier gas. Specifically, the silica particles in an amount of from 0.1 mg to 10 mg inclusive are introduced into the pyrolysis gas chromatography mass spectrometer, and the presence or absence of the molybdenum/nitrogen-containing compound is checked from an MS spectrum of detected peaks. Examples of the components generated by pyrolysis of the silica particles containing the molybdenum/nitrogen-containing compound include primary, secondary, and tertiary amines represented by formula (2) below and aromatic nitrogen compounds. R¹, R², and R³ in formula (2) are the same as R¹, R², and R³ in formula (1). When the molybdenum/nitrogen-containing compound is a quaternary ammonium salt, part of its side chains breaks off during the pyrolysis at 600° C., and a tertiary amine is thereby detected.

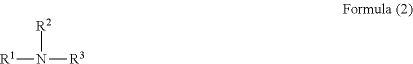

### —Elemental Nitrogen-Containing Compound Containing No Elemental Molybdenum—

In the silica particles (S), an elemental nitrogen-containing compound containing no elemental molybdenum may adhere to the pores in the reaction product of the silane coupling agent. The elemental nitrogen-containing compound containing no elemental molybdenum is, for example, at least one selected from the group consisting of quaternary ammonium salts, primary amine compounds, secondary amine compounds, tertiary amine compounds, amide compounds, imine compounds, and nitrile compounds. The elemental nitrogen-containing compound containing no elemental molybdenum is preferably a quaternary ammonium salt.

Specific examples of the primary amine compound include phenethylamine, toluidine, catecholamine, and 2,4,6-trimethylaniline.

Specific examples of the secondary amine compound include dibenzylamine, 2-nitrodiphenylamine, and 4-(2-octylamino)diphenylamine.

Specific examples of the tertiary amine compound include, 1,8-bis(dimethylamino)naphthalene, N,N-dibenzyl-2-aminoethanol, and N-benzyl-N-methylethanolamine.

Specific examples of the amide compound include N-cyclohexyl-p-toluenesulfonamide, 4-acetamido-1-benzylpiperidine, and N-hydroxy-3-[l-(phenylthio)methyl-1H-1,2,3-triazol-4-yl]benzamide.

Specific examples of the imine compound include diphenylmethanimine, 2,3-bis(2,6-diisopropylphenylimino)butane, and N,N′-(ethane-1,2-diylidene)bis(2,4,6-trimethylaniline).

Specific examples of the nitrile compound include 3-indoleacetonitrile, 4-[(4-chloro-2-pyrimidinyl)amino]benzonitrile, and 4-bromo-2,2-diphenylbutyronitrile.

Examples of the quaternary ammonium salt include compounds represented by formula (AM) below. One of the compounds represented by formula (AM) may be used, or two or more of them may be used.

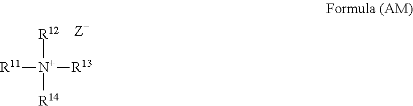

In formula (AM), R¹¹, R¹², R¹³, and R¹⁴ each independently represent a hydrogen atom, an alkyl group, an aralkyl group, or an aryl group, and Z⁻ represents a negative ion. However, at least one of R¹¹, R¹², R¹³, and R¹⁴ represents an alkyl group, an aralkyl group, or an aryl group. Two or more of R¹¹, R¹², R¹³, and R¹⁴ may be bonded together to form an aliphatic ring, an aromatic ring, or a heterocycle. The alkyl group, the aralkyl group, and the aryl group may each have a substituent.

Examples of the alkyl groups represented by R¹¹ to R¹⁴ include linear alkyl groups having 1 to 20 carbon atoms and branched alkyl groups having 3 to 20 carbon atoms. Examples of the linear alkyl group having 1 to 20 carbon atoms include a methyl group, an ethyl group, a n-propyl group, a n-butyl group, a n-pentyl group, a n-hexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, and a n-hexadecyl group. Examples of the branched alkyl group having 3 to 20 carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

The alkyl groups represented by R¹¹ to R¹⁴ may each be an alkyl group having 1 to 15 carbon atoms such as a methyl group, an ethyl group, a butyl group, or a tetradecyl group.

Examples of the aralkyl groups represented by R¹¹ to R¹⁴ include aralkyl groups having 7 to 30 carbon atoms. Examples of the aralkyl group having 7 to 30 carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracylmethyl group, and a phenyl-cyclopentylmethyl group.

The aralkyl groups represented by R¹¹ to R¹⁴ may each be an aralkyl group having 7 to 15 carbon atoms such as a benzyl group, a phenylethyl group, a phenylpropyl group, or a 4-phenylbutyl group.

Examples of the aryl groups represented by R¹¹ to R¹⁴ include aryl groups having 6 to 20 carbon atoms. Examples of the aryl group having 6 to 20 carbon atoms include a phenyl group, a pyridyl group, and a naphthyl group.

The aryl groups represented by R¹¹ to R¹⁴ may each be an aryl group having 6 to 10 carbon atoms such as a phenyl group.

Examples of the ring formed by bonding two or more of R¹¹, R¹², R¹³, and R¹⁴ together include alicycles having 2 to 20 carbon atoms and heterocyclic amines having 2 to 20 carbon atoms.

R¹¹, R¹², R¹³, and R¹⁴ may each independently have a substituent. Examples of the substituent include a nitrile group, a carbonyl group, an ether group, an amido group, a siloxane group, a silyl group, and a silane alkoxy group.

R¹¹, R¹², R¹³, and R¹⁴ may each independently represent an alkyl group having 1 to 16 carbon atoms, an aralkyl group having 7 to 10 carbon atoms, or an aryl group having 6 to 20 carbon atoms.

The negative ion represented by Z⁻ may be an organic negative ion or may be an inorganic negative ion.

Examples of the organic negative ion include polyfluoroalkylsulfonate ions, polyfluoroalkylcarboxylate ions, tetraphenylborate ions, aromatic carboxylate ions, and aromatic sulfonate ions (such as a 1-naphthol-4-sulfonate ion).

Examples of the inorganic negative ion include OH⁻, F⁻, Fe(CN)₆³⁻, Cl⁻, Br⁻, NO₂⁻, NO₃⁻, CO₃²⁻, PO₄³⁻, and SO₄²⁻.

From the viewpoint of narrowing the charge distribution and retainability of the charge distribution, the total number of carbon atoms in the compound represented by formula (AM) is preferably from 18 to 35 inclusive and more preferably from 20 to 32 inclusive.

Examples of the compound represented by formula (AM) are shown below. However, the present exemplary embodiment is not limited thereto.

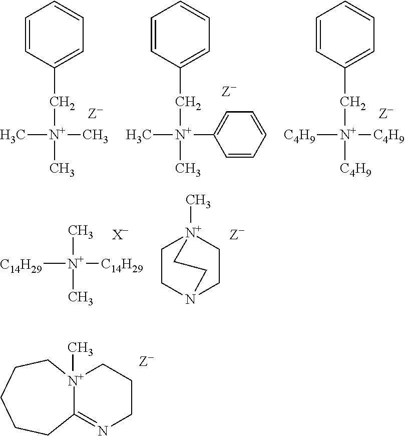

From the viewpoint of narrowing the charge distribution and retainability of the charge distribution, the total amount of the molybdenum/nitrogen-containing compound and the elemental nitrogen-containing compound containing no elemental molybdenum in the silica particles (S) in terms of the mass ratio N/Si of elemental nitrogen to elemental silicon is preferably from 0.005 to 0.50 inclusive, more preferably from 0.008 to 0.45 inclusive, still more preferably from 0.015 to 0.20 inclusive, and yet more preferably from 0.018 to 0.10 inclusive.

The mass ratio N/Si in the silica particles (S) is determined as the mass ratio (N/Si) of N atoms to Si atoms that is measured using an oxygen-nitrogen analyzer (e.g., EMGA-920 manufactured by HORIBA Ltd.) for an integration time of 45 seconds. The sample is subjected to pretreatment, i.e., vacuum drying at 100° C. for 24 hours or longer, to remove impurities such as ammonia.

The total extracted amount X of the molybdenum/nitrogen-containing compound and the elemental nitrogen-containing compound containing no elemental molybdenum that are extracted from the silica particles (S) with an ammonia/methanol solution mixture may be 0.1% by mass or more with respect to the mass of the silica particles (S). In addition, the total extracted amount X of the molybdenum/nitrogen-containing compound and the elemental nitrogen-containing compound containing no elemental molybdenum that are extracted from the silica particles (S) with the ammonia/methanol solution mixture and the total extracted amount Y of the molybdenum/nitrogen-containing compound and the elemental nitrogen-containing compound containing no elemental molybdenum that are extracted from the silica particles (S) with water (in terms of mass percentage with respect to the mass of the silica particles (S), as is X) may satisfy Y/X<0.3.

The above relation indicates that the elemental nitrogen-containing compound contained in the silica particles (S) does not readily dissolve in water, i.e., does not readily absorb moisture in air. Therefore, when the above relation is satisfied, the charge distribution in the silica particles (S) can be easily narrowed, and the charge distribution retainability is high.

The extracted amount X may be from 0.25% by mass to 6.5% by mass inclusive with respect to the mass of the silica particles (S). The ratio Y/X of the extracted amount Y to the extracted amount X is ideally 0.

The extracted amount X and the extracted amount Y are measured by the following method.

The silica particles are analyzed using a thermogravimetry mass spectrometer (for example, a gas chromatography mass spectrometer manufactured by NETZSCH Japan K.K.) at 400° C. The mass percentage of compounds in which nitrogen atoms and hydrocarbons having one or more carbon atoms are bonded through covalent bonds with respect to the silica particles is measured, integrated, and used as W1.

One part by mass of the silica particles are added to 30 parts by mass of an ammonia/methanol solution (manufactured by Sigma-Aldrich, ammonia/methanol mass ratio=1/5.2) with a solution temperature of 25° C. The mixture is subjected to ultrasonic treatment for 30 minutes, and then the silica powder and the extract are separated from each other. The separated silica particles are dried in a vacuum dryer at 100° C. for 24 hours, and the mass percentage of the compounds in which nitrogen atoms and hydrocarbons having one or more carbon atoms are bonded through covalent bonds with respect to the silica particles is measured at 400° C. using the thermogravimetry mass spectrometer, integrated, and used as W2.

One part by mass of the silica particles are added to 30 parts by mass of water with a solution temperature of 25° C. The mixture is subjected to ultrasonic treatment for 30 minutes, and then the silica powder and the extract are separated from each other. The separated silica particles are dried in a vacuum dryer at 100° C. for 24 hours, and the mass percentage of the compounds in which nitrogen atoms and hydrocarbons having one or more carbon atoms are bonded through covalent bonds with respect to the silica particles is measured at 400° C. using the thermogravimetry mass spectrometer, integrated, and used as W3.
W1 and W2 are used to compute the extracted amount X=W1−W2.
W1 and W3 are used to compute the extracted amount Y=W1−W3.

### —Hydrophobic-Treated Structure—

In the silica particles (S), the hydrophobic-treated structure (the structure formed by treating the silica particles with a hydrophobizing agent) may adhere to the coating structure of the reaction product of the silane coupling agent.

The hydrophobizing agent used may be an organic silicon compound. Examples of the organic silicon compound include the following compounds.

Alkoxysilane compounds and halosilane compounds each having a lower alkyl group such as methyltrimethoxysilane, dimethyldimethoxysilane, trimethylchlorosilane, and trimethylmethoxysilane.

Alkoxysilane compounds each having a vinyl group such as vinyltrimethoxysilane and vinyltriethoxysilane.

Alkoxysilane compounds each having an epoxy group such as 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, and 3-glycidoxypropyltriethoxysilane.

Alkoxysilane compounds each having a styryl group such as p-styryltrimethoxysilane and p-styryltriethoxysilane.

Alkoxysilane compounds each having an aminoalkyl group such as N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, and N-phenyl-3-aminopropyltrimethoxysilane.

Alkoxysilane compounds each having an isocyanatoalkyl group such as 3-isocyanatopropyltrimethoxysilane and 3-isocyanatopropyltriethoxysilane.

Silazane compounds such as hexamethyldisilazane and tetramethyldisilazane.

From the viewpoint of narrowing the charge distribution and retainability of the charge distribution, the silica particles (S) may have the following characteristics.

### —Average Circularity, Average Primary Particle Diameter, and Number-Based Particle Size Distribution Index—

The average circularity of the silica particles (S) is preferably from 0.80 to 1.00 inclusive, more preferably from 0.85 to 1.00 inclusive, and still more preferably from 0.88 to 1.00 inclusive.

The average primary particle diameter of the silica particles (S) is preferably from 10 nm to 120 nm inclusive, more preferably from 20 nm to 110 nm inclusive, still more preferably from 30 nm to 100 nm inclusive, and particularly preferably from 40 nm to 90 nm inclusive.

The number-based particle size distribution index of the silica particles (S) is preferably from 1.1 to 2.0 inclusive and more preferably from 1.15 to 1.6 inclusive.

The average circularity, average primary particle diameter, and number-based particle size distribution index of the silica particles (S) are measured by the following method.

A scanning electron microscope (SEM) (S-4800 manufactured by Hitachi High-Technologies Corporation) equipped with an energy dispersive X-ray analyzer (EDX analyzer) (EMAX Evolution X-Max 80 mm² manufactured by HORIBA Ltd.) is used to capture an image of the toner at a magnification of 40000X. EDX analysis is performed to identify 200 silica particles (S) in one viewing field on the basis of the presence of elemental Mo, elemental N, and elemental Si. The image of the 200 silica particles (S) is analyzed using image processing analyzer software WinRoof (MITANI CORPORATION). The equivalent circle diameter, area, and peripheral length of each of the primary particle images are determined, and then the circularity=4π×(the area of the particle image)/(the peripheral length of the particle image)² is determined. The circularity at a cumulative frequency of 50% cumulated from the small side in the circularity distribution is defined as the average circularity. The equivalent circle diameter at a cumulative frequency of 50% cumulated from the small diameter side in the equivalent circle diameter distribution is defined as the average primary particle diameter. The particle diameter at a cumulative frequency of 16% cumulated from the small diameter side in the equivalent circle diameter distribution is defined as D16, and the particle diameter at a cumulative frequency of 84% is defined as D84. Then the number-based particle size distribution index=(D84/D16)^{0.5} is determined.

### —Hydrophobicity—

The hydrophobicity of the silica particles (S) is preferably from 10% to 60% inclusive, more preferably from 20% to 55% inclusive, and still more preferably from 28% to 53% inclusive.

The hydrophobicity of the silica particles is measured using the following method.

The silica particles are added to 50 mL of ion exchanged water in an amount of 0.2% by mass. While the mixture is stirred using a magnetic stirrer, methanol is added dropwise from a burette, and the mass percentage of methanol in the methanol-water solution mixture at the endpoint at which the entire sample has sunk is determined as the hydrophobicity.

### —Volume Resistivity—

The volume resistivity R of the silica particles (S) is preferably from 1.0×10⁷ Ω·cm to 1.0×10^{12.5} Ω·cm inclusive, more preferably from 1.0×10^{7.5} Ω·cm to 1.0×10¹² Ω·cm inclusive, still more preferably from 1.0×10⁸ Ω·cm to 1.0×10¹¹⁵ Ω·cm inclusive, and yet more preferably from 1.0×10⁹ Ω·cm to 1.0×10¹¹ Ω·cm inclusive. The volume resistivity R of the silica particles (S) can be controlled by changing the content of the molybdenum/nitrogen-containing compound.

Let the volume resistivities of the silica particles (S) before and after firing at 350° C. be Ra and Rb, respectively. Then the ratio Ra/Rb is preferably from 0.01 to 0.8 inclusive and more preferably from 0.015 to 0.6 inclusive.

The volume resistivity Ra of the silica particles (S) before firing at 350° C. (which is the same as the volume resistivity R described above) is preferably from 1.0×10⁷ Ω·cm to 1.0×10^{12.5} Ω·cm inclusive, more preferably from 1.0×10^{7.5} Ω·cm to 1.0×10¹² Ω·cm inclusive, still more preferably from 1.0×10⁸ Ω·cm to 1.0×10^{11.5} Ω·cm inclusive, and yet more preferably from 1.0×10⁹ Ω·cm to 1.0×10¹¹ Ω·cm inclusive.

The firing at 350° C. is performed as follows. The silica particles (S) are heated to 350° C. at a heating rate of 10° C./minute in a nitrogen environment, held at 350° C. for 3 hours, and cooled to room temperature (25° C.) at a cooling rate of 10° C./minute.

The volume resistivity of the silica particles (S) is measured in an environment of a temperature of 20° C. and a relative humidity of 50% as follows.

The silica particles (S) are placed to a thickness of about 1 mm to about 3 mm inclusive on a surface of a circular jig with a 20 cm² electrode plate placed thereon to form a silica particle layer. A 20 cm² electrode plate is placed on the silica particle layer to sandwich the silica particle layer between the electrode plates, and a pressure of 0.4 MPa is applied to the electrode plates to eliminate air gaps between the silica particles. Then the thickness L (cm) of the silica particle layer is measured. An impedance analyzer (manufactured by Solartron Analytical) connected to the electrodes on the upper and lower sides of the silica particle layer is used to obtain a Nyquist plot in the frequency range of from 10⁻³ Hz to 10⁶ Hz inclusive. The results are fitted to an equivalent circuit on the assumption that there are three resistance components, i.e., bulk resistance, particle interface resistance, and electrode contact resistance, to thereby determine the bulk resistance R (Ω). The bulk resistance R (Ω) and the thickness L (cm) are used to compute the volume resistivity ρ (Ω·cm) of the silica particles from the formula ρ=R/L.

### —Number of OH Groups—

The number of OH groups in the silica particles (S) is preferably from 0.05/nm² to 6/nm² inclusive, more preferably from 0.1/nm² to 5.5/nm² inclusive, still more preferably from 0.15/nm² to 5/nm² inclusive, yet more preferably from 0.2/nm² to 4/nm² inclusive, and even more preferably from 0.2/nm² to 3/nm² inclusive.

The number of OH groups on the silica particles is measured by the Sears method as follows.

1.5 g of the silica particles are added to a water 50 g/ethanol 50 g solution mixture, and the mixture is stirred using an ultrasonic homogenizer for 2 minutes to produce a dispersion. While the dispersion is stirred in an environment of 25° C., 1.0 g of a 0.1 mol/L aqueous hydrochloric acid solution is added dropwise to obtain a test solution. The test solution is placed in an automatic titrator, and potentiometric titration is performed using a 0.01 mol/L aqueous sodium hydroxide solution to produce a differential titration curve. A titer at an inflection point at which the derivative of the titration curve is 1.8 or more and the titer of the 0.01 mol/L aqueous sodium hydroxide is maximum is defined as E.

The density ρ of silanol groups (the number of silanol groups/nm²) on the surfaces of the silica particles is computed from the following formula and used as the number of OH groups on the silica particles.

ρ=((0.01×E−0.1)×NA/1000)/(M×S_{BET}×10¹⁸) Formula:

E: the titer at the inflection point at which the derivative of the titration curve is 1.8 or more and the titer of the 0.01 mol/L aqueous sodium hydroxide is maximum, NA: Avogadro's number, M: the amount of the silica particles (1.5 g), S_{BET}: the BET specific surface area (m²/g) of the silica particles measured by the three-point nitrogen adsorption method (equilibrium relative pressure: 0.3).

### —Pore Diameter—

In the pore size distribution curve determined by the nitrogen gas adsorption method, the silica particles (S) have a first peak preferably in a pore diameter range of from 0.01 nm to 2 nm inclusive and a second peak preferably in a pore diameter range of from 1.5 nm to 50 nm inclusive, more preferably in a range of from 2 nm to 50 nm inclusive, still more preferably in a range of from 2 nm to 40 nm inclusive, and yet more preferably in a range of from 2 nm to 30 nm inclusive.

When the first peak and the second peak are in the above ranges, the molybdenum/nitrogen-containing compound penetrates deep into the pores in the coating structure, and the charge distribution is narrowed.

The pore size distribution curve is determined by the nitrogen gas adsorption method as follows.

The silica particles are cooled to liquid nitrogen temperature (−196° C.), and nitrogen gas is introduced to determine the adsorption amount of the nitrogen gas by the constant volume method or gravimetric method. The pressure of the nitrogen gas introduced is gradually increased, and the amount of nitrogen gas adsorbed is plotted against the equilibrium pressure to produce an adsorption isotherm. A pore diameter distribution curve with the vertical axis representing the frequency and the horizontal axis representing the pore diameter is determined from the adsorption isotherm according to the calculation formula of the BJH method. A cumulative pore volume distribution with the vertical axis representing the volume and the horizontal axis representing the pore diameter is determined from the obtained pore diameter distribution curve, and the positions of pore diameter peaks are checked.

From the viewpoint of narrowing the charge distribution and retainability of the charge distribution, the silica particles (S) may satisfy mode (A) or mode (B) described below.

Mode (A): Let the pore volumes in a pore diameter range of from 1 nm to 50 nm inclusive in the pore size distribution curves determined by the nitrogen gas adsorption method before and after firing at 350° C. be A and B, respectively. Then the ratio B/A is from 1.2 to 5 inclusive, and B is from 0.2 cm³/g to 3 cm³/g inclusive.

The “pore volume A in the pore diameter range of from 1 nm to 50 nm inclusive in the pore size distribution curve determined by the nitrogen gas adsorption method before firing at 350° C.” is referred to as the “pore volume A before firing at 350° C.,” and the pore volume B in the pore diameter range of from 1 nm to 50 nm inclusive in the pore size distribution curve determined by the nitrogen gas adsorption method after firing at 350° C.” is referred to as the “pore volume B after firing at 350° C.”

The firing at 350° C. is performed as follows. The silica particles (S) are heated to 350° C. at a heating rate of 10° C./minute in a nitrogen environment, held at 350° C. for 3 hours, and cooled to room temperature (25° C.) at a cooling rate of 10° C./minute.

The pore volume is measured by the following method.

The silica particles are cooled to liquid nitrogen temperature (−196° C.), and nitrogen gas is introduced to determine the adsorption amount of the nitrogen gas by the constant volume method or gravimetric method. The pressure of the nitrogen gas introduced is gradually increased, and the amount of nitrogen gas adsorbed is plotted against the equilibrium pressure to produce an adsorption isotherm. A pore diameter distribution curve with the vertical axis representing the frequency and the horizontal axis representing the pore diameter is determined from the adsorption isotherm according to the calculation formula of the BJH method. A cumulative pore volume distribution with the vertical axis representing the volume and the horizontal axis representing the pore diameter is determined from the obtained pore diameter distribution curve. The pore volume in the obtained cumulative pore volume distribution is integrated in the pore diameter range of from 1 nm to 50 nm inclusive, and the integrated value is used as the “pore volume in the pore diameter range of from 1 nm to 50 nm inclusive.”

The ratio B/A of the pore volume B after firing at 350° C. to the pore volume A before firing at 350° C. is preferably from 1.2 to 5 inclusive, more preferably from 1.4 to 3 inclusive, and still more preferably from 1.4 to 2.5 inclusive.

The pore volume B after firing at 350° C. is preferably from 0.2 cm³/g to 3 cm³/g inclusive, more preferably from 0.3 cm³/g to 1.8 cm³/g inclusive, and still more preferably from 0.6 cm³/g to 1.5 cm³/g inclusive.

In the mode (A), a sufficient amount of the elemental nitrogen-containing compound is adsorbed to at least part of the pores in the silica particles.

Mode (B): in a ²⁹Si solid nuclear magnetic resonance (NMR) spectrum by the cross-polarization/magic-angle spinning (CP/MAS) method (hereinafter referred to as a “Si—CP/MAS NMR spectrum”), the ratio C/D of the integrated value C of a signal observed in a chemical shift range of from −50 ppm to −75 ppm inclusive to the integrated value D of a signal observed in a chemical shift range of from −90 ppm to −120 ppm inclusive is from 0.10 to 0.75 inclusive.

The Si—CP/MAS NMR spectrum is obtained by performing nuclear magnetic resonance spectrometric analysis under the following conditions.
Spectroscope: AVANCE 300 (manufactured by Bruker)
Resonance frequency: 59.6 MHz
Measurement nucleus: ²⁹Si
Measurement method: CPMAS method (using standard pulse sequence cp.av from Bruker)
Waiting time: 4 seconds
Contact time: 8 milliseconds
Number of scans: 2048
Measurement temperature: room temperature (measured value: 25° C.)
Observation center frequency: −3975.72 Hz
MAS spinning rate: 7.0 mm-6 kHz
Reference material: hexamethylcyclotrisiloxane

The ratio C/D is preferably from 0.10 to 0.75 inclusive, more preferably from 0.12 to 0.45 inclusive, and still more preferably from 0.15 to 0.40 inclusive.

The percentage (signal ratio) of the integrated value C of the signal observed in the chemical shift range of from −50 ppm to −75 ppm inclusive with the integrated value of the entire signal in the Si—CP/MAS NMR spectrum set to 100% is preferably 5% or more and more preferably 7% or more. The upper limit of the percentage of the integrated value C of the signal is, for example, 60% or less.

In the mode (B), the low-density coating structure capable of adsorbing a sufficient amount of the elemental nitrogen-containing compound is formed on at least part of the surfaces of the silica particles. The low-density coating structure is, for example, a coating structure formed from the reaction product of the silane coupling agent (particularly, the trifunctional silane coupling agent) and is, for example, a SiO_{2/3}CH₃ layer.

### [Method for Producing Silica Particles (S)]

An example of a method for producing the silica particles (S) includes: a first step of forming the coating structure formed from the reaction product of the silane coupling agent on at least part of the surfaces of the silica base particles; and a second step of causing the molybdenum/nitrogen-containing compound to adhere to the coating structure. This production method may further include a third step of, after or during the second step, subjecting the silica base particles having the coating structure to hydrophobization treatment. These steps will next be described in detail.

### —Silica Base Particles—

The silica base particles are prepared through step (i) or step (ii) below.
Step (i): the step of preparing a silica base particle suspension by mixing a solvent containing an alcohol and the silica base particles.
Step (ii): the step of obtaining a silica base particle suspension by forming the silica base particles using the sol-gel method.

The silica base particles used in the step (i) may be dry silica or may be wet silica. Specific examples of the silica base particles include sol-gel silica particles, aqueous colloidal silica particles, alcoholic silica particles, fumed silica particles, and fused silica particles.

The alcohol-containing solvent used in the step (i) may be a solvent composed only of the alcohol or may be a solvent mixture of the alcohol and an additional solvent. Examples of the alcohol include lower alcohols such as methanol, ethanol, n-propanol, isopropanol, and butanol. Examples of the additional solvent include: water; ketones such as acetone, methyl ethyl ketone, and methyl isobutyl ketone; cellosolves such as methyl cellosolve, ethyl cellosolve, butyl cellosolve, and cellosolve acetate; and ethers such as dioxane and tetrahydrofuran. When the solvent mixture is used, the ratio of the alcohol is preferably 80% by mass or more and more preferably 85% by mass or more.

The step (ii) may be a sol-gel method including: an alkaline catalyst solution preparing step of preparing an alkaline catalyst solution in which an alkaline catalyst is contained in a solvent containing an alcohol; and a silica base particle forming step of forming the silica base particles by supplying tetraalkoxysilane and an alkaline catalyst to the alkaline catalyst solution.

The alkaline catalyst solution preparing step may be a step of preparing the alcohol-containing solvent and mixing the solvent and the alkaline catalyst to obtain the alkaline catalyst solution.

The alcohol-containing solvent may be a solvent composed only of the alcohol or may be a solvent mixture of the alcohol and an additional solvent. Examples of the alcohol include lower alcohols such as methanol, ethanol, n-propanol, isopropanol, and butanol. Examples of the additional solvent include: water; ketones such as acetone, methyl ethyl ketone, and methyl isobutyl ketone; cellosolves such as methyl cellosolve, ethyl cellosolve, butyl cellosolve, and cellosolve acetate; and ethers such as dioxane and tetrahydrofuran. When the solvent mixture is used, the ratio of the alcohol is preferably 80% by mass or more and more preferably 85% by mass or more.

The alkaline catalyst is a catalyst for facilitating the reactions of the tetraalkoxysilane (hydrolysis and condensation reactions). Examples of the catalyst include basic catalysts such as ammonia, urea, and monoamines, and ammonia may be used.

The concentration of the alkaline catalyst in the alkaline catalyst solution is preferably from 0.5 mol/L to 1.5 mol/L inclusive, more preferably from 0.6 mol/L to 1.2 mol/L inclusive, and still more preferably from 0.65 mol/L to 1.1 mol/L inclusive.

The silica base particle forming step is the step of forming the silica base particles by supplying the tetraalkoxysilane and an alkaline catalyst to the alkaline catalyst solution to allow the reactions (hydrolysis and condensation reactions) of the tetraalkoxysilane to proceed in the alkaline catalyst solution.

In the silica base particle forming step, nuclear particles are formed by the reactions of the tetraalkoxysilane during the initial stage of supply of the tetraalkoxysilane (nuclear particle formation stage), and the nuclear particles are allowed to grow (nuclear particle growth stage), whereby the silica base particles are formed.

Examples of the tetraalkoxysilane include tetramethoxysilane, tetraethoxysilane, tetrapropoxysilane, and tetrabutoxysilane. From the viewpoint of the controllability of the reaction rate and the uniformity of the shapes of the silica base particles to be formed, tetramethoxysilane or tetraethoxysilane may be used.

Examples of the alkaline catalyst supplied to the alkaline catalyst solution include basic catalysts such as ammonia, urea, and monoamines, and ammonia may be used. The alkaline catalyst supplied together with the tetraalkoxysilane may be the same as the alkaline catalyst contained in advance in the alkaline catalyst solution or may be different therefrom. The same alkaline catalyst may be used.

The tetraalkoxysilane and the alkaline catalyst may be supplied continuously to the alkaline catalyst solution or may be supplied intermittently to the alkaline catalyst solution.

In the silica base particle forming step, the temperature of the alkaline catalyst solution (its temperature during supply) is preferably from 5° C. to 50° C. inclusive and more preferably from 15° C. to 45° C. inclusive.

### —First Step—

The first step is the step of forming the coating structure formed from the reaction product of the silane coupling agent by, for example, adding the silane coupling agent to the silica base particle suspension to allow the silane coupling agent to react on the surfaces of the silica base particles.

The silane coupling agent is allowed to react by, for example, after the addition of the silane coupling agent to the silica base particle suspension, heating the suspension under stirring. Specifically, for example, the suspension is heated to from 40° C. to 70° C. inclusive. Then the silane coupling agent is added, and the mixture is stirred. The stirring is continued for preferably from 10 minutes to 24 hours inclusive, more preferably from 60 minutes to 420 minutes inclusive, and still more preferably from 80 minutes to 300 minutes inclusive.

### —Second Step—

The second step may be the step of allowing the molybdenum/nitrogen-containing compound to adhere to the pores in the coating structure formed from the reaction product of the silane coupling agent.

In the second step, for example, the molybdenum/nitrogen-containing compound is added to the silica base particle suspension that has been reacted with the silane coupling agent, and the mixture is stirred while its temperature is maintained in the temperature range of from 20° C. to 50° C. inclusive. The molybdenum/nitrogen-containing compound may be added to the silica particle suspension as an alcohol solution containing the molybdenum/nitrogen-containing compound. The alcohol may be the same alcohol as that contained in the silica base particle suspension or may be different therefrom. The same alcohol may be used. In the alcohol solution containing the molybdenum/nitrogen-containing compound, the concentration of the molybdenum/nitrogen-containing compound is preferably from 0.05% by mass to 10% by mass inclusive and more preferably from 0.1% by mass to 6% by mass inclusive.

### —Third Step—

The third step is the step of causing the hydrophobic-treated structure to further adhere to the coating structure formed from the reaction product of the silane coupling agent. The third step is a hydrophobization treatment step performed after or during the second step. With the hydrophobizing agent, functional groups in the hydrophobizing agent are reacted with each other, and/or the functional groups in the hydrophobizing agent are reacted with OH groups in the silica base particles, so that a hydrophobization treatment layer is formed.

In the third step, for example, the molybdenum/nitrogen-containing compound is added to the silica base particle suspension that has been reacted with the silane coupling agent, and then the hydrophobizing agent is added. In this case, the suspension may be stirred and heated. For example, the suspension is heated to from 40° C. to 70° C. inclusive. Then the hydrophobizing agent is added, and the mixture is stirred. The stirring is continued for preferably from 10 minutes to 24 hours inclusive, more preferably from 20 minutes to 120 minutes inclusive, and still more preferably from 20 minutes to 90 minutes inclusive.

### —Drying Step—

After or during the second step or the third step, a drying step of removing the solvent from the suspension may be performed. Examples of the drying method include thermal drying, spray drying, and supercritical drying.

The spray drying can be performed using a well-known method using a spray dryer (such as a rotary disc-type or nozzle-type dryer). For example, the silica particle suspension is sprayed into a hot gas stream at a rate of from 0.2 L/hour to 1 L/hour inclusive. The temperature of the hot gas is preferably in the range of from 70° C. to 400° C. inclusive at the inlet of the spay dryer and in the range of from 40° C. to 120° C. inclusive at the outlet of the spay dryer. The temperature at the inlet is more preferably in the range of from 100° C. to 300° C. inclusive. The concentration of the silica particles in the silica particle suspension may be from 10% by mass to 30% by mass inclusive.

Examples of the material used as the supercritical fluid for the supercritical drying include carbon dioxide, water, methanol, ethanol, and acetone. From the viewpoint of the efficiency of the treatment and from the viewpoint of reducing the generation of coarse particles, the supercritical fluid may be supercritical carbon dioxide. Specifically, the step using the supercritical carbon dioxide is performed according to the following procedure.

The suspension is placed in a sealed reaction vessel, and then liquid carbon dioxide is introduced into the sealed reaction vessel. The sealed reaction vessel is then heated, and the pressure inside the sealed reaction vessel is increased using a high-pressure pump to bring the carbon dioxide in the sealed reaction vessel into a supercritical state. Next, liquid carbon dioxide is introduced into the sealed reaction vessel so that the supercritical carbon dioxide flows out from the sealed reaction vessel, and the supercritical carbon dioxide is thereby allowed to circulate through the suspension in the sealed reaction vessel. While the supercritical carbon dioxide circulates through the suspension, the solvent is dissolved in the supercritical carbon dioxide and removed together with the supercritical carbon dioxide flowing out from the sealed reaction vessel. The temperature and pressure inside the sealed reaction vessel are those at which carbon dioxide becomes supercritical. The critical point of carbon dioxide is 31.1° C./7.38 MPa. Therefore, the temperature is, for example, from 40° C. to 200° C. inclusive, and the pressure is, for example, from 10 MPa to 30 MPa inclusive. The flow rate of the supercritical fluid into the sealed reaction vessel may be from 80 mL/second to 240 mL/second inclusive.

The silica particles obtained may be pulverized or sieved to remove coarse particles and aggregates. The pulverization is performed using, for example, a dry pulverizing machine such as a jet mill, a vibration mill, a ball mill, or a pin mill. The sieving is performed using, for example, a vibrating sieve or air sieving machine.

### [Silica Particles (E)]

An external additive other than the perovskite compound particles and the silica particles (S) may be externally added to the toner according to the present exemplary embodiment. This external additive may be silica particles other than the silica particles (S). In the present disclosure, the silica particles other than the silica particles (S) are referred to as silica particles (E).

The silica particles (E) may contain an elemental nitrogen-containing compound containing elemental molybdenum. In this case, the ratio N_{Mo}/N_{Si} of the Net intensity N_{Mo} of elemental molybdenum measured by X-ray fluorescence analysis to the Net intensity N_{Si} of elemental Si measured by the X-ray fluorescence analysis is less than 0.035 or more than 0.45.

The silica particles (E) may be silica particles containing no elemental nitrogen-containing compound containing elemental molybdenum.

The silica particles (E) may be hydrophobic silica particles (E) obtained by treating the surfaces of silica particles such as sol-gel silica particles, aqueous colloidal silica particles, alcoholic silica particles, fumed silica particles, or fused silica particles with a hydrophobizing agent (such as a silane-based coupling agent, a silicone oil, a titanate-based coupling agent, an aluminum-based coupling agent, or a silazane compound).

The average primary particle diameter of the silica particles (E) (preferably the hydrophobic silica particles (E)) is preferably from 80 nm to 200 nm inclusive, more preferably from 90 nm to 170 nm inclusive, and still more preferably from 100 nm to 140 nm inclusive.

The average circularity of the silica particles (E) (preferably the hydrophobic silica particles (E)) is preferably from 0.80 to 1.00 inclusive, more preferably from 0.85 to 0.98 inclusive, and still more preferably from 0.90 to 0.95 inclusive.

The average circularity and average primary particle diameter of the silica particles (E) are measured by the following method.

A scanning electron microscope (SEM) (S-4800 manufactured by Hitachi High-Technologies Corporation) equipped with an energy dispersive X-ray analyzer (EDX analyzer) (EMAX Evolution X-Max 80 mm² manufactured by HORIBA Ltd.) is used to capture an image of the toner at a magnification of 40000X. On the basis of the presence of the elemental Mo, elemental N, and elemental Si in the EDX analysis, the silica particles (S) are excluded, and 200 silica particles (E) in one viewing field are identified. The image of the 200 silica particles (E) is analyzed using image processing analyzer software WinRoof (MITANI CORPORATION). The equivalent circle diameter, area, and peripheral length of each of the primary particle images are determined, and then the circularity=4π×(the area of the particle image)/(the peripheral length of the particle image)² is determined. The circularity at a cumulative frequency of 50% cumulated from the small side in the circularity distribution is defined as the average circularity. The equivalent circle diameter at a cumulative frequency of 50% cumulated from the small diameter side in the equivalent circle diameter distribution is defined as the average primary particle diameter.

In one exemplary embodiment of the toner according to the present exemplary embodiment, the toner contains the perovskite compound particles, the silica particles (S) having an average primary particle diameter of from 30 nm to 100 nm inclusive, and the silica particles (E) having an average primary particle diameter of from 100 nm to 140 nm inclusive.

When the toner according to the present exemplary embodiment contains the silica particles (E), the amount of the silica particles (E) (preferably the hydrophobic silica particles (E)) externally added is preferably from 0.1 parts by mass to 3.0 parts by mass inclusive, more preferably from 0.1 parts by mass to 2.0 parts by mass inclusive, and still more preferably from 0.1 parts by mass to 1.5 parts by mass inclusive, based on 100 parts by mass of the toner particles.

### [Additional Additives]

External additives other than the perovskite compound particles and the silica particles may be externally added to the toner according to the present exemplary embodiment. Examples of the external additives include particles of inorganic materials such as TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surfaces of the inorganic particles serving as an external additive may be subjected to hydrophobization treatment. The hydrophobization treatment is performed, for example, by immersing the inorganic particles in a hydrophobizing agent. No particular limitation is imposed on the hydrophobizing agent. Examples of the hydrophobizing agent include silane-based coupling agents, silicone oils, titanate-based coupling agents, and aluminum-based coupling agents. Any one of them may be used alone, or two or more of them may be used in combination.

The amount of the hydrophobizing agent is generally, for example, from 1 part by mass to 10 parts by mass inclusive based on 100 parts by mass of the inorganic particles.

Other examples of the external additives include resin particles (particles of resins such as polystyrene, polymethyl methacrylate, and melamine resins) and cleaning activators (such as a metal salt of a higher fatty acid typified by zinc stearate and particles of a fluorine-based high-molecular weight material).

When the toner contains the external additives other than the perovskite compound particles and the silica particles, the total amount of the external additives is preferably from 0.01% by mass to 5% by mass inclusive and more preferably from 0.01% by mass to 2.0% by mass inclusive, based on the mass of the toner particles.

### [Method for Producing Toner]

The toner according to the present exemplary embodiment is obtained by producing toner particles and then externally adding external additives to the toner particles produced.

The toner particles may be produced by a dry production method (such as a kneading-grinding method) or by a wet production method (such as an aggregation/coalescence method, a suspension polymerization method, or a dissolution/suspension method). No particular limitation is imposed on the toner particle production method, and any known production method may be used. In particular, the aggregation/coalescence method may be used to obtain the toner particles.

Specifically, when the toner particles are produced, for example, by the aggregation/coalescence method, the toner particles are produced through: the step of preparing a resin particle dispersion in which resin particles used as the binder resin are dispersed (a resin particle dispersion preparing step); the step of aggregating the resin particles (and other optional particles) in the resin particle dispersion (the dispersion may optionally contain an additional particle dispersion mixed therein) to form aggregated particles (an aggregated particle forming step); and the step of heating the aggregated particle dispersion with the aggregated particles dispersed therein to fuse and coalesce the aggregated particles to thereby form the toner particles (a fusion/coalescence step).

These steps will next be described in detail.

In the following, a method for obtaining toner particles containing the coloring agent and the release agent will be described, but the coloring agent and the release agent are used optionally. Of course, an additional additive other than the coloring agent and the release agent may be used.

### —Resin Particle Dispersion Preparing Step—

The resin particle dispersion in which the resin particles used as the binder resin are dispersed is prepared, and, for example, a coloring agent particle dispersion in which coloring agent particles are dispersed and a release agent particle dispersion in which release agent particles are dispersed are prepared.

The resin particle dispersion is prepared, for example, by dispersing the resin particles in a dispersion medium using a surfactant.

Examples of the dispersion medium used for the resin particle dispersion include aqueous mediums.

Examples of the aqueous medium include: water such as distilled water and ion exchanged water; and alcohols. Any of these may be used alone or in combination of two or more.

Examples of the surfactant include: anionic surfactants such as sulfate-based surfactants, sulfonate-based surfactants, phosphate-based surfactants, and soap-based surfactants; cationic surfactants such as amine salt-based surfactants and quaternary ammonium salt-based surfactants; and nonionic surfactants such as polyethylene glycol-based surfactants, alkylphenol ethylene oxide adduct-based surfactants, and polyhydric alcohol-based surfactants. Of these, an anionic surfactant or a cationic surfactant may be used. A nonionic surfactant may be used in combination with the anionic surfactant or the cationic surfactant.

Any of these surfactants may be used alone or in combination of two or more.

To disperse the resin particles in the dispersion medium to form the resin particle dispersion, a commonly used dispersing method that uses, for example, a rotary shearing-type homogenizer, a ball mill using media, a sand mill, or a dyno-mill may be used. The resin particles may be dispersed in the dispersion medium by a phase inversion emulsification method, but this depends on the type of resin particles. In the phase inversion emulsification method, the resin to be dispersed is dissolved in a hydrophobic organic solvent that can dissolve the resin, and a base is added to an organic continuous phase (O phase) to neutralize it. Then the aqueous medium (W phase) is added to change the form of the resin from W/O to O/W, and the resin is thereby dispersed as particles in the aqueous medium.

The volume average diameter of the resin particles dispersed in the resin particle dispersion is, for example, preferably from 0.01 μm to 1 μm inclusive, more preferably from 0.08 μm to 0.8 μm inclusive, and still more preferably from 0.1 μm to 0.6 μm inclusive.

The volume average particle diameter of the resin particles is measured as follows. A particle size distribution measured by a laser diffraction particle size measurement apparatus (e.g., LA-700 manufactured by HORIBA Ltd.) is used and divided into different particle diameter ranges (channels), and a cumulative volume distribution computed from the small particle diameter side is determined. The particle diameter at which the cumulative frequency is 50% is measured as the volume average particle diameter D50v. The volume average diameters of particles in other dispersions are measured in the same manner.

The content of the resin particles contained in the resin particle dispersion is preferably from 5% by mass to 50% by mass inclusive and more preferably from 10% by mass to 40% by mass inclusive.

For example, the coloring agent particle dispersion and the release agent particle dispersion are prepared in a similar manner to the resin particle dispersion. Specifically, the descriptions of the volume average diameter of the particles in the resin particle dispersion, the dispersion medium for the resin particle dispersion, the dispersing method, and the content of the resin particles are applicable to the coloring agent particles dispersed in the coloring agent particle dispersion and the release agent particles dispersed in the release agent particle dispersion.

### —Aggregated Particle Forming Step—

Next, the resin particle dispersion, the coloring agent particle dispersion, and the release agent particle dispersion are mixed.

Then the resin particles, the coloring agent particles, and the release agent particles are hetero-aggregated in the dispersion mixture to form aggregated particles containing the resin particles, the coloring agent particles, and the release agent particles and having diameters close to the diameters of target toner particles.

Specifically, for example, a flocculant is added to the dispersion mixture, and the pH of the dispersion mixture is adjusted to acidic (for example, a pH of from 2 to 5 inclusive). Then a dispersion stabilizer is optionally added, and the resulting mixture is heated to a temperature close to the glass transition temperature of the resin particles (specifically, for example, a temperature from the glass transition temperature of the resin particles—30° C. to the glass transition temperature—10° C. inclusive) to aggregate the particles dispersed in the dispersion mixture to thereby form aggregated particles. In the aggregated particle forming step, the flocculant may be added at room temperature (e.g., 25° C.) while the dispersion mixture is agitated, for example, in a rotary shearing-type homogenizer. Then the pH of the dispersion mixture is adjusted to acidic (e.g., a pH of from 2 to 5 inclusive), and the dispersion stabilizer is optionally added. Then the resulting mixture is heated.

Examples of the flocculant include a surfactant with a polarity opposite to the polarity of the surfactant contained in the dispersion mixture, inorganic metal salts, and divalent or higher polyvalent metal complexes. When a metal complex is used as the flocculant, the amount of the surfactant used can be small, and charging characteristics are improved.

An additive that forms a complex with a metal ion in the flocculant or a similar bond may be optionally used together with the flocculant. The additive used may be a chelating agent.

Examples of the inorganic metal salts include: metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

The chelating agent used may be a water-soluble chelating agent. Examples of the chelating agent include: oxycarboxylic acids such as tartaric acid, citric acid, and gluconic acid; and amino carboxylic acids such as iminodiacetic acid (IDA), nitrilotriacetic acid (NTA), and ethylenediaminetetraacetic acid (EDTA).

The amount of the chelating agent added is preferably from 0.01 parts by mass to 5.0 parts by mass inclusive and more preferably 0.1 parts by mass or more and less than 3.0 parts by mass based on 100 parts by mass of the resin particles.

### —Fusion/Coalescence Step—

Next, the aggregated particle dispersion in which the aggregated particles are dispersed is heated, for example, to a temperature equal to or higher than the glass transition temperature of the resin particles (e.g., a temperature higher by 10° C. to 30° C. than the glass transition temperature of the resin particles) to fuse and coalesce the aggregated particles to thereby form toner particles.

The toner particles are obtained through the above-described steps.

Alternatively, the toner particles may be produced through: the step of, after the preparation of the aggregated particle dispersion containing the aggregated particles dispersed therein, mixing the aggregated particle dispersion further with the resin particle dispersion containing the resin particles dispersed therein and then causing the resin particles to adhere to the surfaces of the aggregated particles to aggregate them to thereby form second aggregated particles; and the step of heating a second aggregated particle dispersion containing the second aggregated particles dispersed therein to fuse and coalesce the second aggregated particles to thereby form toner particles having the core-shell structure.

After completion of the fusion/coalescence step, the toner particles in the dispersion are subjected to a well-known washing step, a solid-liquid separation step, and a drying step to obtain dried toner particles. From the viewpoint of chargeability, the toner particles may be subjected to displacement washing with ion exchanged water sufficiently in the washing step. From the viewpoint of productivity, suction filtration, pressure filtration, etc. may be performed in the solid-liquid separation step. From the viewpoint of productivity, freeze-drying, flash drying, fluidized drying, vibrating fluidized drying, etc. may be performed in the drying step.

The toner according to the present exemplary embodiment is produced, for example, by adding the external additives to the dried toner particles obtained and mixing them. The mixing may be performed, for example, using a V blender, a Henschel mixer, a Loedige mixer, etc. If necessary, coarse particles in the toner may be removed using a vibrating sieving machine, an air sieving machine, etc.

### <Electrostatic Image Developer>

An electrostatic image developer according to the present exemplary embodiment contains at least the toner according to the present exemplary embodiment.

The electrostatic image developer according to the present exemplary embodiment may be a one-component developer containing only the toner according to the present exemplary embodiment or may be a two-component developer containing a mixture of the toner and a carrier.

No particular limitation is imposed on the carrier, and any well-known carrier may be used. Examples of the carrier include: a coated carrier prepared by coating the surface of a core material formed of a magnetic powder with a resin; a magnetic powder-dispersed carrier prepared by dispersing a magnetic powder in a matrix resin; and a resin-impregnated carrier prepared by impregnating a porous magnetic powder with a resin.

In each of the magnetic powder-dispersed carrier and the resin-impregnated carrier, the particles forming the carrier may be used as cores, and the surfaces of the cores may be coated with a resin.

Examples of the magnetic powder include: magnetic metal powders such as iron powder, nickel powder, and cobalt powder; and magnetic oxide powders such as ferrite powder and magnetite powder.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylate copolymers, straight silicone resins having organosiloxane bonds and modified products thereof, fluorocarbon resins, polyesters, polycarbonates, phenolic resins, and epoxy resins. The coating resin and the matrix resin may contain an additional additive such as electrically conductive particles. Examples of the electrically conductive particles include: particles of metals such as gold, silver, and copper; and particles of carbon black, titanium oxide, zinc oxide, tin oxide, barium sulfate, aluminum borate, and potassium titanate.

To coat the surface of the core material with a resin, the surface of the core material may be coated with a coating layer-forming solution prepared by dissolving the coating resin and various additives (which are optionally used) in an appropriate solvent. No particular limitation is imposed on the solvent, and the solvent may be selected in consideration of the type of resin used, ease of coating, etc.

Specific examples of the resin coating method include: an immersion method in which the core material is immersed in the coating layer-forming solution; a spray method in which the coating layer-forming solution is sprayed onto the surface of the core material; a fluidized bed method in which the coating layer-forming solution is sprayed onto the core material floated by the flow of air; and a kneader-coater method in which the core material of the carrier and the coating layer-forming solution are mixed in a kneader coater and then the solvent is removed.

The mixing ratio (mass ratio) of the toner and the carrier in the two-component developer is preferably toner:carrier=1:100 to 30:100 and more preferably 3:100 to 20:100.

### <Image Forming Apparatus and Image Forming Method>

An image forming apparatus and an image forming method according to the present exemplary embodiment will be described.

The image forming apparatus according to the present exemplary embodiment includes: an image holding member; a charging device that charges a surface of the image holding member; an electrostatic image forming device that forms an electrostatic image on the charged surface of the image holding member; a developing device that houses an electrostatic image developer and develops, as a toner image, the electrostatic image formed on the surface of the image holding member with the electrostatic image developer; a transferring device that transfers the toner image formed on the surface of the image holding member onto a surface of a recording medium; and a fixing device that fixes the toner image transferred onto the surface of the recording medium. The electrostatic image developer used is the electrostatic image developer according to the present exemplary embodiment.

In the image forming apparatus according to the present exemplary embodiment, an image forming method (an image forming method according to the present exemplary embodiment) is performed. The image forming method includes: charging the surface of the image holding member; forming an electrostatic image on the charged surface of the image holding member; developing, as a toner image, the electrostatic image formed on the surface of the image holding member with the electrostatic image developer according to the present exemplary embodiment; transferring the toner image formed on the surface of the image holding member onto a surface of a recording medium; and fixing the toner image transferred onto the surface of the recording medium.

The image forming apparatus according to the present exemplary embodiment may be applied to known image forming apparatuses such as: a direct transfer-type apparatus that transfers a toner image formed on the surface of the image holding member directly onto a recording medium; an intermediate transfer-type apparatus that first-transfers a toner image formed on the surface of the image holding member onto the surface of an intermediate transfer body and second-transfers the toner image transferred onto the surface of the intermediate transfer body onto the surface of a recording medium; an apparatus including a cleaning device that cleans the surface of the image holding member after the transfer of the toner image but before charging; and an apparatus including a charge eliminating device that eliminates charges on the surface of the image holding member after transfer of the toner image but before charging by irradiating the surface of the image holding member with charge eliminating light.

When the image forming apparatus according to the present exemplary embodiment is the intermediate transfer-type apparatus, the transferring device includes, for example: an intermediate transfer body having a surface onto which a toner image is to be transferred; a first transferring device that first-transfers a toner image formed on the surface of the image holding member onto the surface of the intermediate transfer body; and a second transferring device that second-transfers the toner image transferred onto the surface of the intermediate transfer body onto the surface of a recording medium.

In the image forming apparatus according to the present exemplary embodiment, for example, a portion including the developing device may have a cartridge structure (process cartridge) that is detachably attached to the image forming apparatus. The process cartridge used may be, for example, a process cartridge including the developing device that houses the electrostatic image developer according to the present exemplary embodiment.

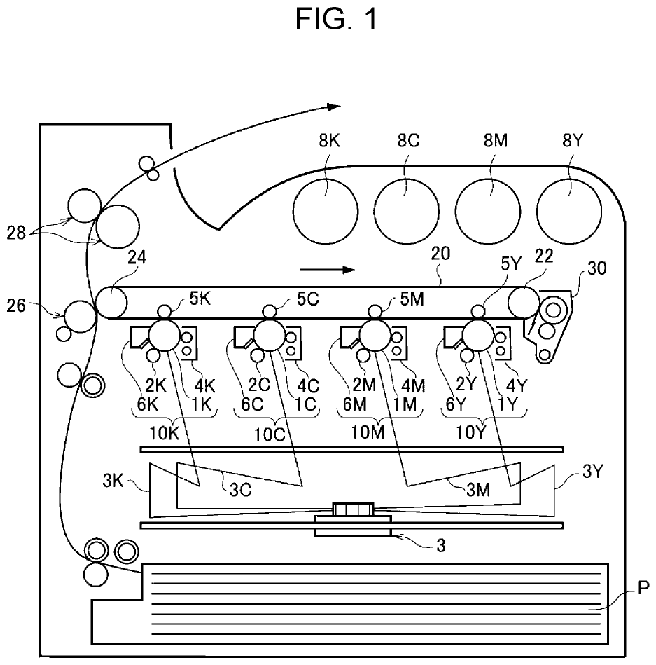

An example of the image forming apparatus according to the present exemplary embodiment will be described, but this is not a limitation. In the following description, major components shown in FIG. 1 will be described, and description of other components will be omitted.

FIG. 1 is a schematic configuration diagram showing the image forming apparatus according to the present exemplary embodiment.

The image forming apparatus shown in FIG. 1 includes first to fourth electrophotographic image forming units 10Y, 10M, 10C, and 10K (image forming devices) that output yellow (Y), magenta (M), cyan (C), and black (K) images, respectively, based on color-separated image data. These image forming units (hereinafter may be referred to simply as “units”) 10Y, 10M, 10C, and 10K are arranged so as to be spaced apart from each other horizontally by a prescribed distance. These units 10Y, 10M, 10C, and 10K may each be a process cartridge detachably attached to the image forming apparatus.

An intermediate transfer belt (an example of the intermediate transfer body) 20 is disposed above the units 10Y, 10M, 10C, and 10K so as to extend through these units. The intermediate transfer belt 20 is wound around a driving roller 22 and a support roller 24 and runs in a direction from the first unit 10Y toward the fourth unit 10K. A force is applied to the support roller 24 by, for example, an unillustrated spring in a direction away from the driving roller 22, so that a tension is applied to the intermediate transfer belt 20 wound around the rollers. An intermediate transfer body cleaner 30 is disposed on an image holding member-side of the intermediate transfer belt 20 so as to be opposed to the driving roller 22.

Yellow, magenta, cyan, and black toners contained in toner cartridges 8Y, 8M, 8C, and 8K, respectively, are supplied to developing units (examples of the developing device) 4Y, 4M, 4C, and 4K, respectively, of the units 10Y, 10M, 10C, and 10K.

The first to fourth units 10Y, 10M, 10C, and 10K have the same structure and operate similarly. Therefore, the first unit 10Y that is disposed upstream in the running direction of the intermediate transfer belt and forms a yellow image will be described as a representative unit.

The first unit 10Y includes a photoconductor 1Y serving as an image holding member. A charging roller (an example of the charging device) 2Y, an exposure unit (an example of the electrostatic image forming device) 3, a developing unit (an example of the developing device) 4Y, a first transfer roller 5Y (an example of the first transferring device), and a photoconductor cleaner (an example of the cleaning device) 6Y are disposed around the photoconductor 1Y in this order. The charging roller charges the surface of the photoconductor 1Y to a prescribed potential, and the exposure unit 3 exposes the charged surface to a laser beam 3Y according to a color-separated image signal to thereby form an electrostatic image. The developing unit 4Y supplies a charged toner to the electrostatic image to develop the electrostatic image, and the first transfer roller 5Y transfers the developed toner image onto the intermediate transfer belt 20. The photoconductor cleaner 6Y removes the toner remaining on the surface of the photoconductor 1Y after the first transfer.

The first transfer roller 5Y is disposed on the inner side of the intermediate transfer belt 20 and placed at a position opposed to the photoconductor 1Y. Bias power sources (not shown) for applying a first transfer bias are connected to the respective first transfer rollers 5Y, 5M, 5C, and 5K of the units. The bias power sources are controlled by an unillustrated controller to change the values of transfer biases applied to the respective first transfer rollers.

A yellow image formation operation in the first unit 10Y will be described.

First, before the operation, the surface of the photoconductor 1Y is charged by the charging roller 2Y to a potential of −600 V to −800 V.

The photoconductor 1Y is formed by stacking a photosensitive layer on a conductive substrate (with a volume resistivity of, for example, 1×10⁻⁶ Ω·cm or less at 20° C.). The photosensitive layer generally has a high resistance (the resistance of a general resin) but has the property that, when irradiated with a laser beam, the specific resistance of a portion irradiated with the laser beam is changed. Therefore, the charged surface of the photoconductor 1Y is irradiated with a laser beam 3Y from the exposure unit 3 according to yellow image data sent from an unillustrated controller. An electrostatic image with a yellow image pattern is thereby formed on the surface of the photoconductor 1Y.

The electrostatic image is an image formed on the surface of the photoconductor 1Y by charging and is a negative latent image formed as follows. The specific resistance of the irradiated portions of the photosensitive layer irradiated with the laser beam 3Y decreases, and this causes charges on the surface of the photoconductor 1Y to flow. However, the charges in portions not irradiated with the laser beam 3Y remain present, and the electrostatic image is thereby formed.

The electrostatic image formed on the photoconductor 1Y rotates to a prescribed developing position as the photoconductor 1Y rotates. Then the electrostatic image on the photoconductor 1Y at the developing position is developed and visualized as a toner image by the developing unit 4Y.

An electrostatic image developer containing, for example, at least a yellow toner and a carrier is contained in the developing unit 4Y. The yellow toner is agitated in the developing unit 4Y and thereby frictionally charged. The charged yellow toner has a charge with the same polarity (negative polarity) as the charge on the photoconductor 1Y and is held on a developer roller (an example of a developer holding member). As the surface of the photoconductor 1Y passes through the developing unit 4Y, the yellow toner electrostatically adheres to charge-eliminated latent image portions on the surface of the photoconductor 1Y, and the latent image is thereby developed with the yellow toner. Then the photoconductor 1Y with the yellow toner image formed thereon continues running at a prescribed speed, and the toner image developed on the photoconductor 1Y is transported to a prescribed first transfer position.

When the yellow toner image on the photoconductor 1Y is transported to the first transfer position, a first transfer bias is applied to the first transfer roller 5Y, and an electrostatic force directed from the photoconductor 1Y toward the first transfer roller 5Y acts on the toner image, so that the toner image on the photoconductor 1Y is transferred onto the intermediate transfer belt 20. The transfer bias applied in this case has a (+) polarity opposite to the (−) polarity of the toner and is controlled to, for example, +10 μA in the first unit 10Y by the controller (not shown).

The toner remaining on the photoconductor 1Y is removed and collected by the photoconductor cleaner 6Y.

The first transfer biases applied to the first transfer rollers 5M, 5C, and 5K of the second unit 10M and subsequent units are controlled in the same manner as in the first unit.

The intermediate transfer belt 20 with the yellow toner image transferred thereon in the first unit 10Y is sequentially transported through the second to fourth units 10M, 10C and 10K, and toner images of respective colors are superimposed and multi-transferred.

Then the intermediate transfer belt 20 with the four color toner images multi-transferred thereon in the first to fourth units reaches a second transfer portion that is composed of the intermediate transfer belt 20, the support roller 24 in contact with the inner surface of the intermediate transfer belt, and a second transfer roller (an example of the second transferring device) 26 disposed on the image holding surface side of the intermediate transfer belt 20. A recording paper sheet (an example of the recording medium) P is supplied to a gap between the second transfer roller 26 and the intermediate transfer belt 20 in contact with each other at a prescribed timing through a supply mechanism, and a second transfer bias is applied to the support roller 24. The transfer bias applied in this case has the same polarity (−) as the polarity (−) of the toner, and an electrostatic force directed from the intermediate transfer belt 20 toward the recording paper sheet P acts on the toner image, so that the toner image on the intermediate transfer belt 20 is transferred onto the recording paper sheet P. In this case, the second transfer bias is determined according to a resistance detected by a resistance detection device (not shown) that detects the resistance of the second transfer portion and is voltage-controlled.

Then the recording paper sheet P is transported to a press contact portion (nip portion) of a pair of fixing rollers in a fixing unit (an example of the fixing device) 28, and the toner image is fixed onto the recording paper sheet P to thereby form a fixed image.

Examples of the recording paper sheet P onto which a toner image is to be transferred include plain paper sheets used for electrophotographic copying machines, printers, etc. Examples of the recording medium include, in addition to the recording paper sheets P, transparencies.

To further improve the smoothness of the surface of a fixed image, it may be necessary that the surface of the recording paper sheet P be smooth. For example, coated paper prepared by coating the surface of plain paper with, for example, a resin, art paper for printing, etc. are suitably used.

The recording paper sheet P with the color image fixed thereon is transported to an ejection portion, and a series of the color image formation operations is thereby completed.

### <Process Cartridge and Toner Cartridge>

A process cartridge according to the present exemplary embodiment will be described.

The process cartridge according to the present exemplary embodiment includes a developing device that houses the electrostatic image developer according to the present exemplary embodiment and develops an electrostatic image formed on the surface of an image holding member with the electrostatic image developer to thereby form a toner image. The process cartridge is detachably attached to the image forming apparatus.

The structure of the process cartridge according to the present exemplary embodiment is not limited to the above-described structure and may include the developing device and at least one optional device selected from other devices such as an image holding member, a charging device, an electrostatic image forming device, and a transferring device.

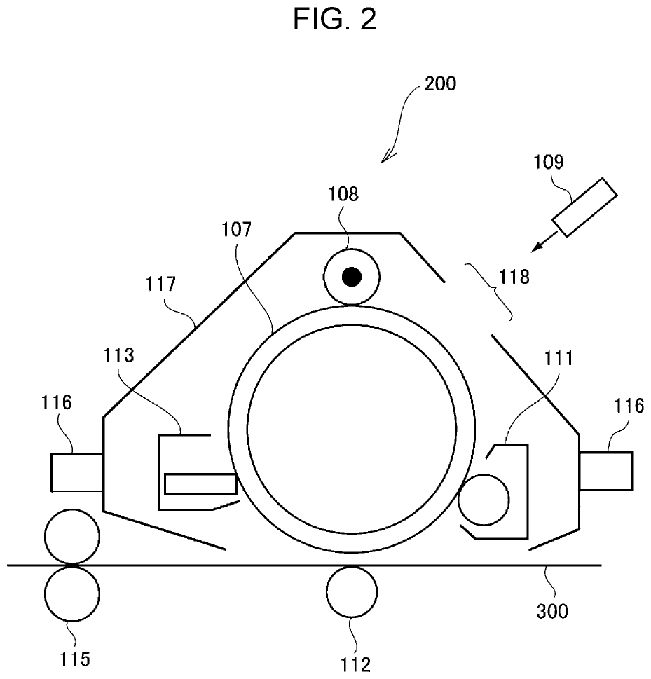

An example of the process cartridge according to the present exemplary embodiment will be described, but this is not a limitation. In the following description, major components shown in FIG. 2 will be described, and description of other components will be omitted.

FIG. 2 is a schematic configuration diagram showing the process cartridge according to the present exemplary embodiment.

The process cartridge 200 shown in FIG. 2 includes, for example, a housing 117 including mounting rails 116 and an opening 118 for light exposure and further includes a photoconductor 107 (an example of the image holding member), a charging roller 108 (an example of the charging device) disposed on the circumferential surface of the photoconductor 107, a developing unit 111 (an example of the developing device), and a photoconductor cleaner 113 (an example of the cleaning device), which are integrally combined and held in the housing 117 to thereby form a cartridge.

In FIG. 2, 109 denotes an exposure unit (an example of the electrostatic image forming device), and 112 denotes a transferring unit (an example of the transferring device). 115 denotes a fixing unit (an example of the fixing device), and 300 denotes a recording paper sheet (an example of the recording medium).

Next, a toner cartridge according to the present exemplary embodiment will be described.

The toner cartridge according to the present exemplary embodiment contains a toner according to the present exemplary embodiment and is detachably attached to an image forming apparatus. The toner cartridge contains a replenishment toner to be supplied to a developing device disposed in the image forming apparatus.

The image forming apparatus shown in FIG. 1 has a structure in which the toner cartridges 8Y, 8M, 8C, and 8K are detachably attached, and the developing units 4Y, 4M, 4C, and 4K are connected to the respective toner cartridges (with respective colors) through unillustrated toner supply tubes. When the amount of the toner contained in a toner cartridge is reduced, this toner cartridge is replaced.

### EXAMPLES

The exemplary embodiment of the disclosure will be described in detail by way of Examples. However, the exemplary embodiment of the disclosure is not limited to these Examples.

In the following description, “parts” and “%” are based on mass, unless otherwise specified.

Synthesis, treatment, production, etc. are performed at room temperature (25° C.±3° C.), unless otherwise specified.

### <Production of Carrier>

Cyclohexyl methacrylate resin (weight average molecular weight: 50000): 54 parts
Carbon black (VXC72 manufactured by Cabot Corporation): 6 parts
Toluene: 250 parts
Isopropyl alcohol: 50 parts

The above materials and glass beads (diameter: 1 mm, in the same amount as that of toluene) are placed in a sand mill, and the mixture is stirred at a rotation speed of 190 rpm for 30 minutes to obtain a coating solution.

1000 Parts of ferrite particles (volume average particle diameter: 35 μm) and 150 parts of the coating solution are placed in a kneader and mixed at room temperature (25° C.) for 20 minutes. Next, the mixture is heated to 70° C. and dried under reduced pressure. The dried product is cooled to room temperature (25° C.). The cooled dried product is removed from the kneader and sieved using a mesh with a mesh size of 75 m to remove coarse powder, and a carrier is thereby obtained.

### <Production of Toner Particles>

### [Preparation of Resin Particle Dispersion (1)]

Ethylene glycol: 37 parts
Neopentyl glycol: 65 parts
1,9-Nonanediol: 32 parts
Terephthalic acid: 96 parts

The above materials are placed in a flask and heated to 200° C. over 1 hour. After confirmation that the reaction system has been uniformly stirred, 1.2 parts of dibutyl tin oxide is added. While water produced is removed by evaporation, the temperature is increased to 240° C. over 6 hours, and the stirring is continued at 240° C. for 4 hours to thereby obtain a polyester resin (acid value: 9.4 mgKOH/g, weight average molecular weight: 13000, glass transition temperature: 62° C.). This polyester resin in a molten state is transferred to an emulsifying-dispersing apparatus (CAVITRON CD1010, EUROTEC Co., Ltd.) at a rate of 100 g/minute. Separately, diluted ammonia water prepared by diluting reagent ammonia water with ion exchanged water to a concentration of 0.37% is placed in a tank. While heated to 120° C. using a heat exchanger, the diluted ammonia water, together with the polyester resin, is transferred to the emulsifying-dispersing apparatus at a rate of 0.1 L/minute. The emulsifying-dispersing apparatus is operated under the following conditions: rotor rotation speed: 60 Hz; and pressure: 5 kg/cm². A resin particle dispersion (1) with a volume average particle diameter of 160 nm and a solid content of 30% is thereby obtained.

### [Preparation of Resin Particle Dispersion (2)]

Decanedioic acid: 81 parts
Hexanediol: 47 parts

The above materials are placed in a flask and heated to 200° C. over 1 hour. After confirmation that the reaction system has been uniformly stirred, 0.03 parts of dibutyl tin oxide is added. While water produced is removed by evaporation, the temperature is increased to 200° C. over 6 hours, and the stirring is continued at 200° C. for 4 hours. Then the reaction solution is cooled and subjected to solid-liquid separation. The solid is dried at a temperature of 40° C. under reduced pressure to thereby obtain a polyester resin (C1) (melting point: 64° C., weight average molecular weight: 15000).
Polyester resin (C1): 50 parts
Anionic surfactant (NEOGEN SC manufactured by DAI-ICHI KOGYO SEIYAKU Co., Ltd.): 2 parts
Ion exchanged water: 200 parts

The above materials are heated to 120° C., sufficiently dispersed using a homogenizer (ULTRA-TURRAX T50, IKA), and then subjected to dispersion treatment using a pressure discharge-type homogenizer. When the volume average particle diameter reaches 180 nm, the product is collected, and a resin particle dispersion (2) with a solid content of 20% is thereby obtained.

### [Preparation of Coloring Agent Particle Dispersion (1)]

Cyan pigment (Pigment Blue 15:3 manufactured by Dainichiseika Color & Chemicals Mfg. Co., Ltd.): 50 parts
Anionic surfactant (NEOGEN SC manufactured by DAI-ICHI KOGYO SEIYAKU Co., Ltd.): 2 parts
Ion exchanged water: 200 parts

The above materials are mixed and dispersed for 1 hour using a high-pressure impact disperser (Ultimaizer HJP30006, Sugino Machine Limited) to thereby obtain a coloring agent particle dispersion (1) with a volume average particle diameter of 180 nm and a solid content of 20%.

### [Preparation of Release Agent Particle Dispersion (1)]

Paraffin wax (HNP-9 manufactured by Nippon Seiro Co., Ltd.): 50 parts
Anionic surfactant (NEOGEN SC manufactured by DAI-ICHI KOGYO SEIYAKU Co., Ltd.): 2 parts
Ion exchanged water: 200 parts

The above materials are heated to 120° C., sufficiently dispersed using a homogenizer (ULTRA-TURRAX T50, IKA), and then subjected to dispersion treatment using a pressure discharge-type homogenizer. When the volume average particle diameter reaches 200 nm, the product is collected, and a release agent particle dispersion (1) with a solid content of 20% is thereby obtained.

### [Production of Toner Particles (1)]

Resin particle dispersion (1): 150 parts
Resin particle dispersion (2): 50 parts
Coloring agent particle dispersion (1): 25 parts
Release agent particle dispersion (1): 35 parts
Polyaluminum chloride: 0.4 parts
Ion exchanged water: 100 parts

The above materials are placed in a stainless steel-made round flask, mixed and dispersed sufficiently using a homogenizer (ULTRA-TURRAXT50, IKA), and then heated to 48° C. in an oil bath for heating while the mixture in the flask is stirred. The reaction system is held at 48° C. for 60 minutes, and then an additional 70 parts of the resin particle dispersion (1) is gently added. Next, a 0.5 mol/L aqueous sodium hydroxide solution is used to adjust the pH to 8.0. The flask is hermetically sealed, and a stirring shaft is magnetically sealed. While the stirring is continued, the reaction system is heated to 90° C. and held for 30 minutes. Next, the resulting mixture is cooled at a cooling rate of 5° C./minute and subjected to solid-liquid separation, and the solid is washed sufficiently with ion exchanged water. Then the resulting mixture is subjected to solid-liquid separation, and the solid is re-dispersed in ion exchanged water at 30° C. and washed by stirring at a rotation speed of 300 rpm for 15 minutes. This washing procedure is repeated 6 times. When the pH of the filtrate reaches 7.54 and its electric conductivity reaches 6.5 S/cm, the mixture is subjected to solid-liquid separation, and the solid is vacuum dried for 24 hours to thereby obtain toner particles (1). The volume average particle diameter of the toner particles (1) is 5.7 μm.

### <Production of Perovskite Compound Particles>

### [Production of Strontium Titanate Particles (1)]

Metatitanic acid serving as a desulfurized and peptized titanium source is collected in an amount of 0.7 moles in terms of TiO₂ and placed in a reaction vessel. Next, an aqueous strontium chloride solution is added in an amount of 0.77 moles to the reaction vessel such that the molar ratio SrO/TiO₂ is 1.1. Then a solution prepared by dissolving lanthanum oxide in nitric acid is added to the reaction vessel such that the amount of lanthanum (La) with respect to 100 moles of strontium is 0.5 moles. The initial TiO₂ concentration in the mixture of these three materials is adjected to 0.75 mol/L. Then the solution mixture is stirred and heated to 92° C. While the temperature of the solution is maintained at 92° C., 153 mL of a ION aqueous sodium hydroxide solution is added over 4.5 hours under stirring. Then, while the temperature of the solution is maintained at 92° C., the stirring is continued for 1 hour. Next, the reaction solution is cooled to 40° C. Then hydrochloric acid is added until the pH of the solution reaches 5.4, and the resulting mixture is stirred for 1 hour. Then decantation and re-dispersion in water are repeated to wash the precipitate. Hydrochloric acid is added to the slurry containing the washed precipitate to adjust the pH to 6.5. The resulting mixture is filtrated to perform solid-liquid separation, and the solid is dried. An ethanol solution of i-butyltrimethoxysilane (i-BTMS) is added to the dried solid such that the amount of i-BTMS with respect to 100 parts of the solid is 20 parts, and the mixture is stirred for 1 hour. The mixture is filtrated to perform solid-liquid separation, and the solid is dried in air at 130° C. for 7 hours to thereby obtain strontium titanate particles (1).

### [Production of Strontium Titanate Particles (2) to (6)]

Strontium titanate particles (2) to (6) are produced using the same procedure as for the production of the strontium titanate particles (1) except that the production conditions are changed as shown in Table 1.

The toner particles and one type of strontium titanate particles are mixed using a Henschel mixer at a stirring peripheral speed of 30 m/second for 15 minutes. Next, the mixture is sieved using a vibrating sieve with a mesh size of 45 m to thereby obtain an external additive-added toner with the strontium titanate particles adhering thereto.

An image of the external additive-added toner is taken at a magnification of 40000X using a scanning electron microscope (SEM) (S-4700 manufactured by Hitachi High-Technologies Corporation). Image information about randomly selected 300 strontium titanate particles is analyzed through an interface using image processing software WinRoof (MITANI CORPORATION), and the equivalent circle diameter of each of the primary particle images is determined. An equivalent circle diameter when a cumulative frequency cumulated from the small diameter side in an equivalent circle diameter distribution is 50% is used as the average primary particle diameter.

TABLE 1

| Strontium titanate particles | | | | Production conditions | | | | | | | | |
|---|---|---|---|---|---|---|---|---|---|---|---|---|
| | | | Average | | | | | | | | Adjustment | |
| | | Surface | primary | | Heating of | | Amount | Addition | | | of pH with | |
| | | treatment | particle | | solution | Holding | of NaOH | time of | Holding | Stirring | hydrochloric | Stirring |
| Name | Dopant | agent | diameter | La | mixture | temperature | added | NaOH | temperature | time | acid | time |
| — | Type | Type | nm | Moles | ° C. | ° C. | mL | Hours | ° C. | Hours | pH | Hours |
| (1) | La | i-BTMS | 50 | 0.5 | 92 | 92 | 153 | 4.5 | 92 | 1 | 5.4 | 1 |
| (2) | La | i-BTMS | 110 | 0.5 | 93 | 93 | 150 | 6.5 | 93 | 1 | 5.3 | 1 |
| (3) | La | i-BTMS | 100 | 0.5 | 93 | 93 | 150 | 6 | 92 | 1 | 5.4 | 1 |
| (4) | La | i-BTMS | 30 | 0.5 | 89 | 89 | 153 | 3.5 | 92 | 1 | 5.4 | 1 |
| (5) | La | i-BTMS | 28 | Strontium titanate particles (4) | | | | | | | | |
| | | | | are classified using airflow classifier | | | | | | | | |
| (6) | None | i-BTMS | 50 | 0 | 92 | 92 | 153 | 4.5 | 92 | 1 | 5.4 | 1 |

### <Production of Silica Particles (S)>

### [Preparation of Alkaline Catalyst Solution]

A glass-made reaction vessel equipped with a metallic stirring rod, a dropping nozzle, and a thermometer is charged with methanol and ammonia water with a concentration shown in Table 2 in amounts shown in Table 2, and the mixture is stirred to thereby obtain an alkaline catalyst solution.

### [Formation of Silica Base Particles by Sol-Gel Method]

The temperature of the alkaline catalyst solution is adjusted to 40° C., and the alkaline catalyst solution is purged with nitrogen. While the solution temperature of the alkaline catalyst solution is maintained at 40° C. under stirring, tetramethoxysilane (TMOS) in an amount shown in Table 2 and 124 parts of ammonia water with a catalyst (NH₃) concentration of 7.9% are simultaneously added dropwise to thereby obtain a silica base particle suspension.

### [Addition of Silane Coupling Agent]

While the solution temperature of the silica base particle suspension is maintained at 40° C. under stirring, methyltrimethoxysilane (MTMS) in an amount shown in Table 2 is added. After completion of the addition, the stirring is continued for 120 minutes to allow the MTMS to react, and at least part of the surfaces of the silica base particles are thereby coated with the reaction product of MTMS.

### [Addition of Molybdenum/Nitrogen-Containing Compound]

A molybdenum/nitrogen-containing compound in an amount shown in Table 2 is diluted with butanol to prepare an alcohol solution. This alcohol solution is added to the silica base particle suspension reacted with the silane coupling agent, and the resulting mixture is stirred for 100 minutes while the solution temperature is maintained at 30° C. The amount of the alcohol solution added is such that the number of parts of the molybdenum/nitrogen-containing compound with respect to 100 parts by mass of the solid in the silica base particle suspension is adjusted to an amount shown in Table 2.

“TP-415” in Table 1 is quaternary ammonium molybdate (Hodogaya Chemical Co., Ltd.).

### [Drying]

The suspension with the molybdenum/nitrogen-containing compound added thereto is transferred to a reaction bath for drying. While the suspension is stirred, liquid carbon dioxide is injected into the reaction bath. The temperature inside the reaction bath is increased to 150° C., and the pressure is increased to 15 MPa. While the temperature and the pressure are held to maintain the supercritical state of carbon dioxide, the stirring of the suspension is continued. Carbon dioxide is caused to flow into and out of the reaction bath at a flow rate of 5 L/minute to remove the solvent over 120 minutes, and silica particles (S) are thereby obtained. By adjusting the amounts of the ammonia water, the silane coupling agent, and the molybdenum/nitrogen-containing compound added, different silica particles (S1) to (S13) are produced.

### [X-Ray Fluorescence Analysis]

Silica particles (S) are subjected to X-ray fluorescence analysis using the measurement method described above to determine the Net intensity N_{Mo} of elemental molybdenum and the Net intensity N_{Si} of elemental silicon, and the Net intensity ratio N_{Mo}/N_{Si} is computed. The results are shown in Table 2.

TABLE 2

| | Formation of | | | | | Molybdenum/nitrogen- | | | | | |
|---|---|---|---|---|---|---|---|---|---|---|---|
| Silica | silica base particles | | | | Surface | containing compound | | Silica particles | | | |
| particles | | Ammonia | Ammonia | | coating | | Amount | Average | | | |
| (S) | Methanol | water | concentration | TMOS | MTMS | | added | particle | Average | | |
| Name | Parts | Parts | % by | Parts | Parts | Material name | Parts | diameter | circularity | N_{Mo} | N_{Mo}/N_{Si} |
| — | by mass | by mass | mass | by mass | by mass | — | by mass | nm | — | kcps | — |
| (S10) | 950 | 166 | 9.6 | 950 | 10 | TP-415 | 0.5 | 50 | 0.88 | 6 | 0.030 |
| (S1) | 950 | 166 | 9.6 | 950 | 22 | TP-415 | 1 | 50 | 0.88 | 8 | 0.035 |
| (S2 | 950 | 166 | 9.6 | 950 | 28 | TP-415 | 3 | 50 | 0.89 | 21 | 0.11 |
| (S3) | 950 | 166 | 9.6 | 950 | 50 | Ditetrakis(dibutyldibenzyl- | 5 | 50 | 0.89 | 31 | 0.16 |
| | | | | | | ammonium)molybdate | | | | | |
| (S4) | 950 | 155 | 9.8 | 950 | 130 | TP-415 | 30 | 50 | 0.83 | 52 | 0.25 |
| (S5) | 950 | 160 | 9.7 | 950 | 130 | TP-415 | 30 | 50 | 0.85 | 53 | 0.25 |
| (S6) | 950 | 166 | 9.6 | 950 | 130 | TP-415 | 30 | 50 | 0.89 | 53 | 0.25 |
| (S7) | 950 | 166 | 9.6 | 950 | 190 | TP-415 | 45 | 50 | 0.90 | 74 | 0.35 |
| (S8) | 950 | 166 | 9.6 | 950 | 230 | TP-415 | 50 | 50 | 0.90 | 86 | 0.40 |
| (S9) | 950 | 166 | 9.6 | 950 | 235 | TP-415 | 52 | 50 | 0.89 | 88 | 0.45 |
| (S11) | 950 | 166 | 9.6 | 950 | 240 | TP-415 | 55 | 50 | 0.89 | 93 | 0.50 |
| (S12) | 950 | 140 | 9.6 | 780 | 115 | TP-415 | 30 | 20 | 0.82 | 52 | 0.25 |
| (S13) | 950 | 150 | 9.6 | 800 | 120 | TP-415 | 30 | 30 | 0.85 | 52 | 0.25 |
| (S14) | 950 | 160 | 9.6 | 850 | 125 | TP-415 | 30 | 40 | 0.88 | 52 | 0.25 |
| (S15) | 950 | 200 | 9.6 | 1000 | 135 | TP-415 | 35 | 85 | 0.89 | 54 | 0.25 |
| (S16) | 950 | 220 | 9.6 | 1100 | 140 | TP-415 | 35 | 100 | 0.91 | 54 | 0.25 |
| (S17) | 950 | 250 | 9.6 | 1200 | 145 | TP-415 | 35 | 120 | 0.93 | 54 | 0.25 |

### Production of Toners and Two-Component Developers

### Example 1

Toner particles (1): 100 parts
Strontium titanate particles (1): 1 part
Silica particles (S1):1 part

The above materials are mixed using a Henschel mixer, and the mixture is sieved using a vibrating sieve with a mesh size of 45 m to thereby obtain a toner. 8 Parts of the toner and 100 parts of the carrier are placed in a V blender and stirred, and the mixture is sieved using a sieve with a mesh size of 212 m to thereby obtain a two-component developer.

### Examples 2 to 28 and Comparative Examples 1 to 2

Toners and two-component developers in Examples and Comparative Examples are obtained using the same procedure as in Example 1 except that the type of strontium titanate particles, their amount added externally, the type of silica particles (S), and their amount added externally are changed as shown in Table 3.

### Example 29

A toner and a two-component developer are obtained using the same procedure as in Example 1 except that calcium titanate particles are used instead of the strontium titanate particles.

### Example 30

A toner and a two-component developer are obtained using the same procedure as in Example 1 except that barium titanate particles are used instead of the strontium titanate particles.

### <Performance Evaluation>

### [Variations in Image Density]

A cyan color two-component developer is filled into a developing unit of an image forming apparatus (DocuCentre Color 400 manufactured by Fuji Xerox Co., Ltd.). Images are formed in an environment of a temperature of 25° C. and a relative humidity of 15% in the following order (1), (2), and (3)

(1) A 5 cm square solid image is formed on 50 A4 plain paper sheets. The solid image on the 50th sheet is referred to as an “image A.”

(2) 26 Letters from A to Z in a 10-point Mincho typeface are formed on 5000 A4 plain paper sheets. In this case, printing is performed at 5 minute intervals.

(3) A 5 cm square solid image is formed on one A4 plain paper sheet. This solid image is referred to as an “image B.”

The image density of each of the images A and B is measured at 10 points using a reflection spectrodensitometer X-Rite 939 (aperture diameter: 4 mm, X-Rite, Incorporated), and the average of the measurements is computed. Then the difference between the average density of the image A and the average density of the image B is computed. The differences are classified as follows. The results are shown in Table 3.

G1: The difference is less than 0.8.

G2: The difference is 0.8 or more and less than 2.0.

G3: The difference is 2.0 or more and less than 2.5.

G4: The difference is 2.5 or more and less than 3.0.

G5: The difference is 3.0 or more.

TABLE 3

| | Strontium | | | | | | | | | | | | | |
|---|---|---|---|---|---|---|---|---|---|---|---|---|---|---|
| | titanate particles | | | | Silica particles (S) | | | | | | | | | |
| | | | Average | | | | Average | | | | | M2/ | | |
| | | | primary | | | | primary | | | | | (M1 + | Variations in | |
| | | | particle | Content | | | particle | Average | Content | | M1 + | M2) × | image density | |
| | | | diameter | M1 | | | diameter | circu- | M2 | | M2 | 100 | Differ- | |
| | Name | Dopant | D1 | Parts | Name | N_{Mo}/N_{Si} | D2 | larity | Parts | D2/D1 | Parts | % by | ence | Class |
| | — | — | nm | by mass | — | — | nm | — | by mass | — | by mass | mass | — | — |
| Comparative | (1) | La | 50 | 1.0 | (S10) | 0.030 | 50 | 0.88 | 1.0 | 1.00 | 2.0 | 50 | 3.5 | G5 |
| Example 1 | | | | | | | | | | | | | | |
| Example 1 | (1) | La | 50 | 1.0 | (S1) | 0.035 | 50 | 0.88 | 1.0 | 1.00 | 2.0 | 50 | 0.8 | G2 |
| Example 2 | (1) | La | 50 | 1.0 | (S2) | 0.11 | 50 | 0.89 | 1.0 | 1.00 | 2.0 | 50 | 0.3 | G1 |
| Example 3 | (1) | La | 50 | 1.0 | (S3) | 0.16 | 50 | 0.89 | 1.0 | 1.00 | 2.0 | 50 | 0.3 | G1 |
| Example 4 | (1) | La | 50 | 1.0 | (S4) | 0.25 | 50 | 0.83 | 1.0 | 1.00 | 2.0 | 50 | 1.0 | G2 |
| Example 5 | (1) | La | 50 | 1.0 | (S5) | 0.25 | 50 | 0.85 | 1.0 | 1.00 | 2.0 | 50 | 1.0 | G2 |
| Example 6 | (1) | La | 50 | 1.0 | (S6) | 0.25 | 50 | 0.89 | 1.0 | 1.00 | 2.0 | 50 | 0.3 | G1 |
| Example 7 | (1) | La | 50 | 1.0 | (S7) | 0.35 | 50 | 0.90 | 1.0 | 1.00 | 2.0 | 50 | 0.7 | G1 |
| Example 8 | (1) | La | 50 | 1.0 | (S8) | 0.40 | 50 | 0.90 | 1.0 | 1.00 | 2.0 | 50 | 1.8 | G2 |
| Example 9 | (1) | La | 50 | 1.0 | (S9) | 0.45 | 50 | 0.89 | 1.0 | 1.00 | 2.0 | 50 | 2.8 | G4 |
| Comparative | (1) | La | 50 | 1.0 | (S11) | 0.50 | 50 | 0.89 | 1.0 | 1.00 | 2.0 | 50 | 3.2 | G5 |
| Example 2 | | | | | | | | | | | | | | |
| Example 10 | (1) | La | 50 | 1.3 | (S6) | 0.25 | 50 | 0.89 | 0.7 | 1.00 | 2.0 | 35 | 0.9 | G2 |
| Example 11 | (1) | La | 50 | 1.2 | (S6) | 0.25 | 50 | 0.89 | 0.8 | 1.00 | 2.0 | 40 | 0.5 | G1 |
| Example 12 | (1) | La | 50 | 0.8 | (S6) | 0.25 | 50 | 0.89 | 1.2 | 1.00 | 2.0 | 60 | 0.5 | G1 |
| Example 13 | (1) | La | 50 | 0.7 | (S6) | 0.25 | 50 | 0.89 | 1.3 | 1.00 | 2.0 | 65 | 2.1 | G3 |
| Example 14 | (1) | La | 50 | 0.3 | (S6) | 0.25 | 50 | 0.89 | 0.2 | 1.00 | 0.5 | 40 | 2.9 | G4 |
| Example 15 | (1) | La | 50 | 0.8 | (S6) | 0.25 | 50 | 0.89 | 1.0 | 1.00 | 1.8 | 56 | 0.9 | G2 |
| Example 16 | (1) | La | 50 | 2.0 | (S6) | 0.25 | 50 | 0.89 | 2.0 | 1.00 | 4.0 | 50 | 0.8 | G2 |
| Example 17 | (1) | La | 50 | 2.5 | (S6) | 0.25 | 50 | 0.89 | 2.5 | 1.00 | 5.0 | 50 | 2.5 | G4 |
| Example 18 | (1) | La | 50 | 1.0 | (S12) | 0.25 | 20 | 0.82 | 1.0 | 0.40 | 2.0 | 50 | 2.5 | G4 |
| Example 19 | (1) | La | 50 | 1.0 | (S13) | 0.25 | 30 | 0.85 | 1.0 | 0.60 | 2.0 | 50 | 1.2 | G2 |
| Example 20 | (1) | La | 50 | 1.0 | (S14) | 0.25 | 40 | 0.88 | 1.0 | 0.80 | 2.0 | 50 | 0.4 | G1 |
| Example 21 | (1) | La | 50 | 1.0 | (S15) | 0.25 | 85 | 0.89 | 1.0 | 1.70 | 2.0 | 50 | 0.4 | G1 |
| Example 22 | (1) | La | 50 | 1.0 | (S16) | 0.25 | 100 | 0.91 | 1.0 | 2.00 | 2.0 | 50 | 1.2 | G2 |
| Example 23 | (1) | La | 50 | 1.0 | (S17) | 0.25 | 120 | 0.93 | 1.0 | 2.40 | 2.0 | 50 | 2.4 | G3 |
| Example 24 | (2) | La | 110 | 1.0 | (S6) | 0.25 | 50 | 0.89 | 1.0 | 0.45 | 2.0 | 50 | 2.4 | G3 |
| Example 25 | (3) | La | 100 | 1.0 | (S6) | 0.25 | 50 | 0.89 | 1.0 | 0.50 | 2.0 | 50 | 0.6 | G1 |
| Example 26 | (4) | La | 30 | 1.0 | (S6) | 0.25 | 50 | 0.89 | 1.0 | 1.67 | 2.0 | 50 | 0.6 | G1 |
| Example 27 | (5) | La | 28 | 1.0 | (S6) | 0.25 | 50 | 0.89 | 1.0 | 1.79 | 2.0 | 50 | 2.5 | G4 |
| Example 28 | (6) | None | 50 | 1.0 | (S6) | 0.25 | 50 | 0.89 | 1.0 | 1.00 | 2.0 | 50 | 2.4 | G3 |
| Example 29 | CaTiO₃ | La | 50 | 1.0 | (S6) | 0.25 | 50 | 0.89 | 1.0 | 1.00 | 2.0 | 50 | 1.2 | G2 |
| Example 30 | BaTiO₃ | La | 50 | 1.0 | (S6) | 0.25 | 50 | 0.89 | 1.0 | 1.00 | 2.0 | 50 | 0.9 | G2 |

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A toner for electrostatic image development including:
toner particles;
perovskite compound particles externally added to the toner particles; and
silica particles (S) that are externally added to the toner particles and include an elemental nitrogen-containing compound containing elemental molybdenum and in which the ratio N_{Mo}/N_{Si} of a Net intensity N_{Mo} of elemental molybdenum that is measured by X-ray fluorescence analysis to a Net intensity N_{Si} of elemental silicon that is measured by the X-ray fluorescence analysis is from 0.035 to 0.45 inclusive.
   (((2)))

The toner for electrostatic image development according to (((1))), wherein the ratio N_{Mo}/N_{Si} in the silica particles (S) is from 0.05 to 0.30 inclusive.

(((3)))

The toner for electrostatic image development according to (((1))) or (((2))), wherein the total content of the perovskite compound particles and the silica particles (S) is from 0.5 parts by mass to 5.0 parts by mass inclusive based on 100 parts by mass of the toner particles.

(((4)))

The toner for electrostatic image development according to any one of (((1))) to (((3))), wherein the mass percentage of the silica particles (S) with respect to the total mass of the perovskite compound particles and the silica particles (S) is from 40% by mass to 60% by mass inclusive.

(((5)))

The toner for electrostatic image development according to any one of (((1))) to (((4))), wherein the ratio D2/D1 of an average primary particle diameter D2 of the silica particles (S) to an average primary particle diameter D1 of the perovskite compound particles is from 0.50 to 1.70 inclusive.

(((6)))

The toner for electrostatic image development according to any one of (((1))) to (((5))), wherein the silica particles (S) have an average primary particle diameter of from 30 nm to 100 nm inclusive.

(((7)))

The toner for electrostatic image development according to any one of (((1))) to (((6))), wherein the silica particles (S) have an average circularity of 0.85 or more.

(((8)))

The toner for electrostatic image development according to any one of (((1))) to (((7))), wherein the perovskite compound particles are strontium titanate particles doped with lanthanum.

(((9)))

The toner for electrostatic image development according to any one of (((1))) to (((8))), wherein the elemental nitrogen-containing compound containing elemental molybdenum is at least one selected from the group consisting of quaternary ammonium salts containing elemental molybdenum and mixtures of quaternary ammonium salts and metal oxides containing elemental molybdenum.

(((10)))

The toner for electrostatic image development according to any one of (((1))) to (((9))), wherein the silica particles (S) are silica particles that include a coating structure formed from a reaction product of a silane coupling agent with the elemental nitrogen-containing compound containing elemental molybdenum adhering to the coating structure.

(((11)))

The toner for electrostatic image development according to (((10))), wherein the silane coupling agent contains an alkyltrialkoxysilane.

(((12)))

An electrostatic image developer containing the toner for electrostatic image development according to any one of (((1))) to (((11))).

(((13)))

A toner cartridge detachably attached to an image forming apparatus, the toner cartridge housing the toner for electrostatic image development according to any one of (((1))) to (((11))).

(((14)))

A process cartridge detachably attached to an image forming apparatus, the process cartridge including a developing device that houses the electrostatic image developer according to (((12))) and develops, as a toner image, an electrostatic image formed on a surface of an image holding member with the electrostatic image developer.

(((15)))

An image forming apparatus including:
an image holding member;
a charging device that charges a surface of the image holding member;
an electrostatic image forming device that forms an electrostatic image on the charged surface of the image holding member;
a developing device that houses the electrostatic image developer according to (((12))) and develops, as a toner image, the electrostatic image formed on the surface of the image holding member with the electrostatic image developer;
a transferring device that transfers the toner image formed on the surface of the image holding member onto a surface of a recording medium; and
a fixing device that fixes the toner image transferred onto the surface of the recording medium.
   (((16)))

An image forming method including:
charging a surface of an image holding member;
forming an electrostatic image on the charged surface of the image holding member;
developing, as a toner image, the electrostatic image formed on the surface of the image holding member with the electrostatic image developer according to (((12)));
transferring the toner image formed on the surface of the image holding member onto a surface of a recording medium; and
fixing the toner image transferred onto the surface of the recording medium.

What is claimed is:

1. A toner for electrostatic image development comprising:
toner particles;
perovskite compound particles externally added to the toner particles; and
silica particles (S) that are externally added to the toner particles and include an elemental nitrogen-containing compound containing elemental molybdenum and in which the ratio N_{Mo}/N_{Si} of a Net intensity N_{Mo} of elemental molybdenum that is measured by X-ray fluorescence analysis to a Net intensity N_{Si} of elemental silicon that is measured by the X-ray fluorescence analysis is from 0.035 to 0.45 inclusive.

2. The toner for electrostatic image development according to claim 1, wherein the ratio N_{Mo}/N_{Si} in the silica particles (S) is from 0.05 to 0.30 inclusive.

3. The toner for electrostatic image development according to claim 1, wherein the total content of the perovskite compound particles and the silica particles (S) is from 0.5 parts by mass to 5.0 parts by mass inclusive based on 100 parts by mass of the toner particles.

4. The toner for electrostatic image development according to claim 1, wherein the mass percentage of the silica particles (S) with respect to the total mass of the perovskite compound particles and the silica particles (S) is from 40% by mass to 60% by mass inclusive.

5. The toner for electrostatic image development according to claim 1, wherein the ratio D2/D1 of an average primary particle diameter D2 of the silica particles (S) to an average primary particle diameter D1 of the perovskite compound particles is from 0.50 to 1.70 inclusive.

6. The toner for electrostatic image development according to claim 5, wherein the average primary particle diameter of the silica particles (S) is from 30 nm to 100 nm inclusive.

7. The toner for electrostatic image development according to claim 1, wherein the silica particles (S) have an average circularity of 0.85 or more.

8. The toner for electrostatic image development according to claim 1, wherein the perovskite compound particles are strontium titanate particles doped with lanthanum.

9. The toner for electrostatic image development according to claim 1, wherein the elemental nitrogen-containing compound containing elemental molybdenum is at least one selected from the group consisting of quaternary ammonium salts containing elemental molybdenum and mixtures of quaternary ammonium salts and metal oxides containing elemental molybdenum.

10. The toner for electrostatic image development according to claim 1, wherein the silica particles (S) are silica particles that include a coating structure formed from a reaction product of a silane coupling agent with the elemental nitrogen-containing compound containing elemental molybdenum adhering to the coating structure.

11. The toner for electrostatic image development according to claim 10, wherein the silane coupling agent contains an alkyltrialkoxysilane.

12. An electrostatic image developer comprising the toner for electrostatic image development according to claim 1.

13. An electrostatic image developer comprising the toner for electrostatic image development according to claim 2.

14. An electrostatic image developer comprising the toner for electrostatic image development according to claim 3.

15. An electrostatic image developer comprising the toner for electrostatic image development according to claim 4.

16. An electrostatic image developer comprising the toner for electrostatic image development according to claim 5.

17. A toner cartridge detachably attached to an image forming apparatus, the toner cartridge comprising the toner for electrostatic image development according to claim 1.

18. A process cartridge detachably attached to an image forming apparatus, the process cartridge comprising a developing device that houses the electrostatic image developer according to claim 12 and develops, as a toner image, an electrostatic image formed on a surface of an image holding member with the electrostatic image developer.

19. An image forming apparatus comprising:
an image holding member;
a charging device that charges a surface of the image holding member;
an electrostatic image forming device that forms an electrostatic image on the charged surface of the image holding member;
a developing device that houses the electrostatic image developer according to claim 12 and develops, as a toner image, the electrostatic image formed on the surface of the image holding member with the electrostatic image developer;
a transferring device that transfers the toner image formed on the surface of the image holding member onto a surface of a recording medium; and
a fixing device that fixes the toner image transferred onto the surface of the recording medium.

20. An image forming method comprising:
charging a surface of an image holding member;
forming an electrostatic image on the charged surface of the image holding member;
developing, as a toner image, the electrostatic image formed on the surface of the image holding member with the electrostatic image developer according to claim 12;
transferring the toner image formed on the surface of the image holding member onto a surface of a recording medium; and
fixing the toner image transferred onto the surface of the recording medium.
